(19) United States
(12) Patent Application Publication
(10) Pub. No.: US 2024/0269638 A1
(43) Pub. Date: Aug. 15, 2024

(54) METHOD FOR PRODUCING HOLLOW FINE PARTICLES, HOLLOW FINE PARTICLES, PHASE SEPARATED FINE PARTICLES, AQUEOUS DISPERSION, AND COMPOSITION

(71) Applicant: DAIKIN INDUSTRIES, LTD., Osaka-Shi (JP)

(72) Inventors: Yoshito TANAKA, Osaka-shi (JP); Mayumi IIDA, Osaka-Shi (JP); Yuuki SUZUKI, Osaka-Shi (JP); Kanako NAKANISHI, Osaka-Shi (JP); Hideto MINAMI, Kobe-shi (JP)

(21) Appl. No.: 18/619,369

(22) Filed: Mar. 28, 2024

Related U.S. Application Data
(63) Continuation of application No. PCT/JP22/37440, filed on Oct. 6, 2022.

(30) Foreign Application Priority Data
Oct. 8, 2021 (JP) 2021-166325

(51) Int. Cl. B01J 13/18; B01J 13/20; C08F 34/02; C08J 9/00; C08J 9/32

(52) U.S. Cl. CPC B01J 13/185; B01J 13/206; C08F 34/02; C08J 9/0061; C08J 9/32; C08F 2810/20; C08J 2345/00

(57) ABSTRACT

The disclosure provides a production method capable of producing a hollow fine particulate containing a fluorine-containing resin and having a large average particle size. The production method includes a step A of dispersing a solution containing a fluorinated monomer and a non-polymerizable solvent into water to provide a dispersion; a step B of polymerizing the fluorinated monomer to provide a phase-separated fine particulate containing a fluorine-containing resin; and a step C of removing the non-polymerizable solvent in the phase-separated fine particulate to provide a hollow fine particulate.

### CROSS-REFERENCE TO RELATED APPLICATIONS

This is a Rule 53(b) Continuation of International Application No. PCT/JP2022/037440 filed Oct. 6, 2022, claiming priority based on Japanese Patent Application No. 2021-166325 filed Oct. 8, 2021, the disclosures of which are incorporated by reference herein in their respective entireties.

### TECHNICAL FIELD

The disclosure relates to methods for producing a hollow fine particulate, hollow fine particulates, phase-separated fine particulates, aqueous dispersions, and compositions.

### BACKGROUND ART

Hollow fine particulates having a pore therein are excellent for achievement of light weight, low refractive index, low dielectricity, and other characteristics and are therefore examined in various studies. Such hollow fine particulates are conventionally formed from inorganic particles, but inorganic particles are heavy in weight. This therefore leads to current studies on hollow fine particulates formed from a polymer instead of inorganic particles.

For example, Patent Literature 1 discloses hollow fine resin particles containing a resin having a fluorine atom, wherein the hollow resin fine particles have an average particle size of 10 to 200 nm, a porosity of 10% or higher, and a refractive index of 1.30 or lower.

Patent Literature 2 discloses a hollow fine particulate containing a fluorine-containing resin and having an average particle size of 70 nm or greater and 10 μm or less.

### CITATION LIST

### Patent Literature

Patent Literature 1: JP 2005-213366 A
Patent Literature 2: JP 2020-183500 A

### SUMMARY OF INVENTION

The disclosure (1) relates to a method for producing a hollow fine particulate including:
a step A of dispersing a solution containing a fluorinated monomer and a non-polymerizable solvent into water to provide a dispersion;
a step B of polymerizing the fluorinated monomer to provide a phase-separated fine particulate containing a fluorine-containing resin; and
a step C of removing the non-polymerizable solvent in the phase-separated fine particulate to provide a hollow fine particulate (hereinafter, also referred to as “the production method of the disclosure).

### Advantageous Effects

The production method of the disclosure can produce a hollow fine particulate containing a fluorine-containing resin and having a large average particle size.

The hollow fine particulate of the disclosure and the phase-separated fine particulate of the disclosure have a large average particle size even though they contain a fluorine-containing resin.

### BRIEF DESCRIPTION OF THE DRAWINGS

FIG. 1A shows an optical micrograph of suspended particles dispersed in water obtained in Example 1.

FIG. 1B shows a SEM photograph of a hollow fine particulate obtained in Example 2.

FIG. 2 shows an optical micrograph of suspended particles dispersed in water obtained in Example 4.

FIG. 3 shows an optical micrograph of suspended particles dispersed in water obtained in Example 7.

FIG. 4A shows an optical micrograph of suspended particles dispersed in water obtained in Example 8.

FIG. 4B shows a SEM photograph of a hollow fine particulate obtained in Example 9.

FIG. 5A shows an optical micrograph of suspended particles dispersed in water obtained in Example 10.

FIG. 5B shows a SEM photograph of a hollow fine particulate obtained in Example 11.

FIG. 6 shows an optical micrograph of suspended particles dispersed in water obtained in Example 12.

FIG. 7 shows an optical micrograph of suspended particles dispersed in water obtained in Example 14.

FIG. 8 shows an optical micrograph of suspended particles dispersed in water obtained in Example 16.

FIG. 9 shows an optical micrograph of suspended particles dispersed in water obtained in Example 23.

FIG. 10 shows an optical micrograph of suspended particles dispersed in water obtained in Example 24.

FIG. 11 shows a SEM photograph of a hollow fine particulate obtained in Example 26.

FIG. 12 shows a SEM photograph of a hollow fine particulate obtained in Example 26.

FIG. 13 shows a SEM photograph of a hollow fine particulate obtained in Example 27.

FIG. 14 shows a SEM photograph of a hollow fine particulate obtained in Example 30.

FIG. 15 shows a SEM photograph of a hollow fine particulate obtained in Example 31.

### DESCRIPTION OF EMBODIMENTS

Some of the terms used in the disclosure are defined or described before specifically describing the disclosure.

The term “organic group” in the disclosure refers to a group containing one or more carbon atom(s) or a group formed by removing one hydrogen atom from an organic compound.

Examples of the “organic group” include:
an alkyl group optionally having one or more substituent(s),
an alkenyl group optionally having one or more substituent(s),
an alkynyl group optionally having one or more substituent(s),
a cycloalkyl group optionally having one or more substituent(s),
a cycloalkenyl group optionally having one or more substituent(s),
a cycloalkadienyl group optionally having one or more substituent(s),
an aryl group optionally having one or more substituent(s),
an aralkyl group optionally having one or more substituent(s),
a non-aromatic heterocyclic group optionally having one or more substituent(s),
a heteroaryl group optionally having one or more substituent(s),
a cyano group,
a formyl group,

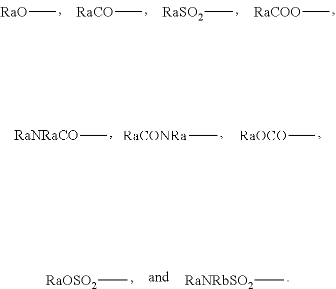

In the formulas, Ra is independently:
an alkyl group optionally having one or more substituent(s),
an alkenyl group optionally having one or more substituent(s),
an alkynyl group optionally having one or more substituent(s),
a cycloalkyl group optionally having one or more substituent(s),
a cycloalkenyl group optionally having one or more substituent(s),
a cycloalkadienyl group optionally having one or more substituent(s),
an aryl group optionally having one or more substituent(s),
an aralkyl group optionally having one or more substituent(s),
a non-aromatic heterocyclic group optionally having one or more substituent(s), or
a heteroaryl group optionally having one or more substituent(s), and
Rb is independently H or an alkyl group optionally having one or more substituent(s).

The organic group is preferably an alkyl group optionally having one or more substituent(s).

The term “substituent” in the disclosure refers to a substitutable group. Examples of the “substituent” include an aliphatic group, an aromatic group, a heterocyclic group, an acyl group, an acyloxy group, an acylamino group, an aliphatic oxy group, an aromatic oxy group, a heterocyclic oxy group, an aliphatic oxycarbonyl group, an aromatic oxycarbonyl group, a heterocyclic oxycarbonyl group, a carbamoyl group, an aliphatic sulfonyl group, an aromatic sulfonyl group, a heterocyclic sulfonyl group, an aliphatic sulfonyloxy group, an aromatic sulfonyloxy group, a heterocyclic sulfonyloxy group, a sulfamoyl group, an aliphatic sulfonamide group, an aromatic sulfonamide group, a heterocyclic sulfonamide group, an amino group, an aliphatic amino group, an aromatic amino group, a heterocyclic amino group, an aliphatic oxycarbonyl amino group, an aromatic oxycarbonyl amino group, a heterocyclic oxycarbonyl amino group, an aliphatic sulfinyl group, an aromatic sulfinyl group, an aliphatic thio group, an aromatic thio group, a hydroxy group, a cyano group, a sulfo group, a carboxy group, an aliphatic oxyamino group, an aromatic oxyamino group, a carbamoylamino group, a sulfamoylamino group, a halogen atom, a sulfamoylcarbamoyl group, a carbamoylsulfamoyl group, a dialiphatic oxyphosphinyl group, and a diaromatic oxyphosphinyl group.

The aliphatic group may be saturated or unsaturated and may have a hydroxy group, an aliphatic oxy group, a carbamoyl group, an aliphatic oxycarbonyl group, an aliphatic thio group, an amino group, an aliphatic amino group, an acylamino group, a carbamoylamino group, or the like. Examples of the aliphatic group include an alkyl group having a total carbon number of 1 to 8, preferably 1 to 4, such as a methyl group, an ethyl group, a vinyl group, a cyclohexyl group, or a carbamoylmethyl group.

The aromatic group may have, for example, a nitro group, a halogen atom, an aliphatic oxy group, a carbamoyl group, an aliphatic oxycarbonyl group, an aliphatic thio group, an amino group, an aliphatic amino group, an acylamino group, a carbamoylamino group, or the like. Examples of the aromatic group include an aryl group having a total carbon number of 6 to 12, preferably a total carbon number of 6 to 10, such as a phenyl group, a 4-nitrophenyl group, a 4-acethylaminophenyl group, or a 4-methanesulfonyl group.

The heterocyclic group may have a halogen atom, a hydroxy group, an aliphatic oxy group, a carbamoyl group, an aliphatic oxycarbonyl group, an aliphatic thio group, an amino group, an aliphatic amino group, an acylamino group, a carbamoylamino group, or the like. Examples of the heterocyclic group include a 5- to 6-membered heterocycle having a total carbon number of 2 to 12, preferably 2 to 10, such as a 2-tetrahydrofuryl group or a 2-pyrimidyl group.

The acyl group may have an aliphatic carbonyl group, an aryl carbonyl group, a heterocyclic carbonyl group, a hydroxy group, a halogen atom, an aromatic group, an aliphatic oxy group, a carbamoyl group, an aliphatic oxycarbonyl group, an aliphatic thio group, an amino group, an aliphatic amino group, an acylamino group, a carbamoylamino group, or the like. Examples of the acyl group include an acyl group having a total carbon number of 2 to 8, preferably 2 to 4, such as an acetyl group, a propanoyl group, a benzoyl group, or a 3-pyridinecarbonyl group.

The acylamino group may have an aliphatic group, an aromatic group, a heterocyclic group, or the like, such as an acetylamino group, a benzoylamino group, a 2-pyridinecarbonylamino group, or a proparanoylamino group. Examples of the acylamino group include an acylamino group having a total carbon number of 2 to 12, preferably 2 to 8 and an alkylcarbonylamino group having a total carbon number of 2 to 8, such as an acetylamino group, a benzoylamino groups, a 2-pyridinecarbonylamino group, or a propanoylamino group.

The aliphatic oxycarbonyl group may be saturated or unsaturated and may contain a hydroxy group, an aliphatic oxy group, a carbamoyl group, an aliphatic oxycarbonyl group, an aliphatic thio group, an amino group, an aliphatic amino group, an acylamino group, a carbamoylamino group, or the like. Examples of the aliphatic oxycarbonyl group include an alkoxycarbonyl group having a total carbon number of 2 to 8, preferably 2 to 4, such as a methoxycarbonyl group, an ethoxycarbonyl group, or a (t)-butoxycarbonyl group.

The carbamoyl group may have an aliphatic group, an aromatic group, a heterocyclic group, or the like. Examples of the carbamoyl group include an unsubstituted carbamoyl group and an alkylcarbamoyl group having a total carbon number of 2 to 9. Preferred examples include an unsubstituted carbamoyl group and an alkylcarbamoyl group having a total carbon number of 2 to 5, such as a N-methylcarbamoyl group, a N,N-dimethylcarbamoyl group, or a N-phenylcarbamoyl group.

The aliphatic sulfonyl group may be saturated or unsaturated and may have a hydroxy group, an aromatic group, an aliphatic oxy group, a carbamoyl group, an aliphatic oxycarbonyl group, an aliphatic thio group, an amino group, an aliphatic amino group, an acylamino group, a carbamoylamino group, or the like. Examples of the aliphatic sulfonyl group include an alkylsulfonyl group having a total carbon number of 1 to 6, preferably 1 to 4, such as a methanesulfonyl group.

The aromatic sulfonyl group may have a hydroxy group, an aliphatic group, an aliphatic oxy group, a carbamoyl group, an aliphatic oxycarbonyl group, an aliphatic thio group, an amino group, an aliphatic amino group, an acylamino group, a carbamoylamino group, or the like. Examples of the aromatic sulfonyl group include an arylsulfonyl group having a total carbon number of 6 to 10, such as a benzenesulfonyl group.

The amino group may have an aliphatic group, an aromatic group, a heterocyclic group, or the like.

The acylamino group may have, for example, an acetylamino group, a benzoylamino group, a 2-pyridine carbonylamino group, a propanoylamino group, or the like. Examples of the acylamino group include an acylamino group having a total carbon number of 2 to 12, preferably 2 to 8. Preferred examples include an alkylcarbonylamino group having a total carbon number of 2 to 8, such as an acetylamino group, a benzoylamino group, a 2-pyridinecarbonylamino group, or a proparanoylamino group.

The aliphatic sulfonamide group, the aromatic sulfonamide group, and the heterocyclic sulfonamide group may be, for example, a methanesulfonamide group, a benzenesulfonamide group, and a 2-pyridine sulfonamide group, respectively.

The sulfamoyl group may have an aliphatic group, an aromatic group, a heterocyclic group, or the like. Examples of the sulfamoyl group include a sulfamoyl group, an alkyl sulfamoyl group having a total carbon number of 1 to 9, a dialkyl sulfamoyl group having a total carbon number of 2 to 10, an aryl sulfamoyl group having a total carbon number of 7 to 13, and a heterocyclic sulfamoyl group having a total carbon number of 2 to 12. Preferred examples include a sulfamoyl group, an alkylsulfamoyl group having a total carbon number of 1 to 7, a dialkylsulfamoyl group having a total carbon number of 3 to 6, an arylsulfamoyl group having a total carbon number of 6 to 11, and a heterocyclic sulfamoyl group having a total carbon number of 2 to 10, such as a sulfamoyl group, a methyl sulfamoyl group, a N,N-dimethyl sulfamoyl group, a phenyl sulfamoyl group, or a 4-pyridine sulfamoyl group.

The aliphatic oxy group may be saturated or unsaturated and may have a methoxy group, an ethoxy group, an i-propyloxy group, a cyclohexyloxy group, a methoxyethoxy group, or the like. Examples of the aliphatic oxy group include an alkoxy group having a total carbon number of 1 to 8, preferably 1 to 6, such as a methoxy group, an ethoxy group, an i-propyloxy group, a cyclohexyloxy group, or a methoxyethoxy group.

The aromatic amino group and the heterocyclic amino group may each have an aliphatic group, an aliphatic oxy group, a halogen atom, a carbamoyl group, a heterocyclic group fused with the aryl group, or an aliphatic oxycarbonyl group, preferably an aliphatic group having a total carbon number of 1 to 4, an aliphatic oxy group having a total carbon number of 1 to 4, a halogen atom, a carbamoyl group having a total carbon number of 1 to 4, a nitro group, or an aliphatic oxycarbonyl group having a total carbon number of 2 to 4.

The aliphatic thio group may be saturated or unsaturated, and examples include an alkylthio group having a total carbon number of 1 to 8, preferably 1 to 6, such as a methylthio group, an ethylthio group, a carbamoylmethylthio group, or a t-butylthio group.

The carbamoylamino group may have an aliphatic group, an aryl group, a heterocyclic group, or the like. Examples of the carbamoylamino group include a carbamoylamino group, an alkylcarbamoylamino group having a total carbon number of 2 to 9, a dialkylcarbamoylamino group having a total carbon number of 3 to 10, an arylcarbamoylamino group having a total carbon number of 7 to 13, and a heterocyclic carbamoylamino group having a total carbon number of 3 to 12. Preferred examples include a carbamoylamino group, an alkylcarbamoylamino group having a total carbon number of 2 to 7, a dialkylcarbamoylamino group having a total carbon number of 3 to 6, an arylcarbamoylamino group having a total carbon number of 7 to 11, and a heterocyclic carbamoylamino group having a total carbon number of 3 to 10, such as a carbamoylamino group, a methylcarbamoylamino group, a N,N-dimethylcarbamoylamino group, a phenylcarbamoylamino group, or a 4-pyridine carbamoylamino group.

In the disclosure, a range defined with endpoints includes all numbers in the range (for example, a range of 1 to 10 includes 1.4, 1.9, 2.33, 5.75, 9.98, and other numbers).

The phrase “at least one” in the disclosure includes all numbers of not smaller than 1 (for example, at least 2, at least 4, at least 6, at least 8, at least 10, at least 25, at least 50, and at least 100).

### (Method for Producing Hollow Fine Particulate)

The production method of the disclosure includes a step A of dispersing a solution containing a fluorinated monomer and a non-polymerizable solvent into water to provide a dispersion; a step B of polymerizing the fluorinated monomer to provide a phase-separated fine particulate containing a fluorine-containing resin; and a step C of removing the non-polymerizable solvent in the phase-separated fine particulate to provide a hollow fine particulate.

The disclosers performed studies to find that, in the case of producing a hollow fine particulate containing a fluorine-containing resin by polymerizing a fluorinated monomer, a hollow fine particulate having a large average particle size is difficult to obtain by conventional methods. The disclosers found that a hollow fine particulate containing a fluorine-containing produced through the steps A to C can have a large average particle size, thereby completing the production method of the disclosure.

The step A is a step of dispersing a solution containing a fluorinated monomer and a non-polymerizable solvent into water to provide a dispersion. Liquid droplets are formed by dispersing the solution. Polymerizing the high-fluorine-conversion monomer in the liquid droplets can provide a phase-separated fine particulate having a large average particle size even if a fluorine resin is contained. Then, a hollow fine particulate having a large average particle size can be obtained by removing the non-polymerizable solvent in the phase-separated fine particulate.

The fluorinated monomer is preferably a high-fluorine-conversion monomer having a high fluorine conversion FC calculated by the following formula:

$$Fluorine conversion FC ( \% ) = ( the number of C - F bonds in a monomer molecule ) \text{} / \{ ( the number of C - F bonds in a monomer molecule ) + ( the number of C - H bonds in a monomer molecule ) \} \times 100.$$

The fluorine conversion FC of the high-fluorine-conversion monomer is preferably 70% or higher, more preferably 80% or higher, still more preferably 100%. Specifically, the high-fluorine-conversion monomer is preferably a perfluoro monomer.

Examples of the high-fluorine-conversion monomer include a high-fluorine-conversion acrylic monomer, a high-fluorine-conversion styrenic monomer, and a high-fluorine-conversion olefin. Preferred among these is a high-fluorine-conversion olefin.

The fluorine conversion FC of the high-fluorine-conversion olefin is preferably 70% or higher, more preferably 80% or higher, still more preferably 100%. Specifically, the high-fluorine-conversion olefin is preferably a perfluoro olefin.

The high-fluorine-conversion olefin is not limited and is suitably a high-fluorine-conversion cyclic olefin or a monomer represented by the following formula (b), (d), or (e) where monomers of the formula (e) exclude monomers of the formula (d):

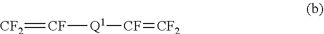

wherein Q¹ is a C1-C5 linear or optionally branched perfluoroalkylene group optionally containing an ether bond;

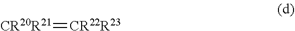

wherein R²⁰ to R²³ are each independently a fluorine atom, a C1-C5 perfluoroalkyl group, or a C1-C5 perfluoroalkoxy group; or

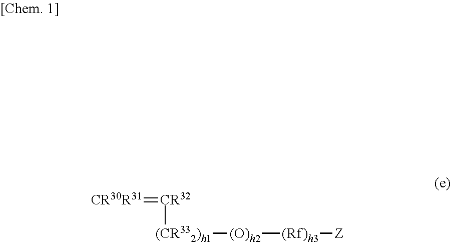

wherein R³⁰ and R³¹ are each independently H or F; R³² is H, F, or CF₃; R³³ is H, F, or CF₃; h1 to h3 are each independently 0 or 1; Z is H, F, Cl, —OH, CH₂OH, —COOH, —COF, a carboxylic acid derivative, —SO₃H, a sulfonic acid derivative, an epoxy group, or a cyano group; and Rf is a C1-C20 linear or branched fluorine-containing alkylene group or a C2-C100 linear or branched fluorine-containing alkylene group containing an ether bond.

In the formula (b), Q¹ is preferably a perfluoroalkylene group containing an ether bond. In this case, the ether bond in the perfluoroalkylene group may be present at one terminal of the group or may be present at both terminals of the group, or may be present between carbon atoms of the group. In order to achieve excellent cyclopolymerizability, the ether bond is preferably present at one terminal of the group.

Examples of the monomer represented by the formula (b) include perfluoro(3-butenyl vinyl ether), perfluoro(aryl vinyl ether), perfluoro(3,5-dioxaheptadiene), and perfluoro(3,5-dioxa-4,4-dimethylheptadiene). Particularly preferred is perfluoro(3-butenyl vinyl ether).

The monomer represented by the formula (b) is a cyclopolymerizable monomer. Examples of a unit formed by cyclopolymerization of the monomer represented by the formula (b) include those represented by the following formulas (II-1) to (II-4). As shown in the following formulas, in the formulas (II-1) to (II-3), four carbon atoms defining two double bonds define the main chain of the polymer, while in the formula (II-4), two terminal carbon atoms defining two double bonds alone define the main chain of the polymer. As in the formula (II-1), two carbon atoms among the four carbon atoms defining the two double bonds may define an aliphatic ring together with Q¹. As in the formulas (II-2) and (II-3), three double bonds may define an aliphatic ring together with Q¹. As in the formula (II-4), four double bonds may define an aliphatic ring together with Q¹. For the aliphatic ring containing Q¹, a 5- or 6-membered ring is easy to generate. A polymer generated by cyclopolymerization is a polymer in which a unit containing a 5- or 6-membered ring serves as a main unit.

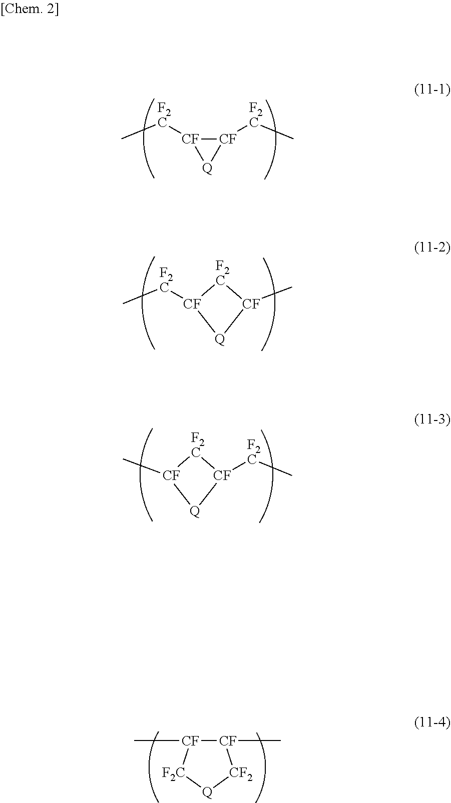

Examples of the monomer represented by the formula (d) include CF₂═CF₂, CF₂═CF(CF₃), CF₂═CF(C₂F₅), CF₂═CF(C₃F₇), CF₂═CF(C₄F₉), CF₂═CF(C₅F₁₁), CF₂═CF(OCF₃), CF₂═CF(OC₂F₅), CF₂═CF(OC₃F₇), CF₂═CF(OC₄F), and CF₂═CF(OC₅F₁₁). Preferred among these are CF₂═CF₂, CF₂═CF(CF₃), CF₂═CF(OCF₃), CF₂═CF(OC₂F₅), and CF₂═CF(OC₃F₇).

The monomer represented by the formula (e) is preferably a monomer represented by the formula: CH₂═CFCF₂ORf-Z (wherein Rf and Z are as described above). Examples of monomers corresponding to this formula include the following monomers:

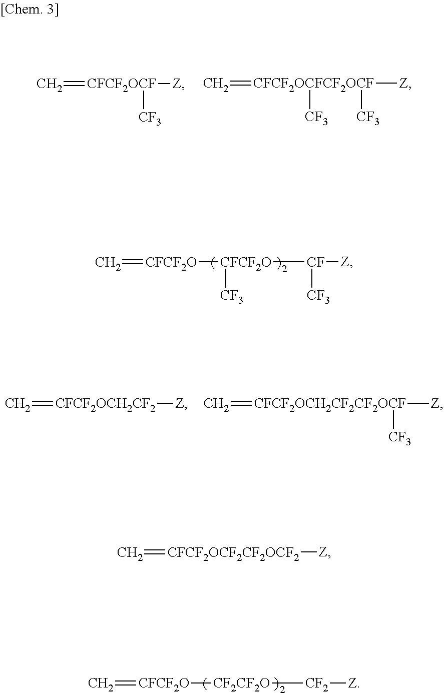

The monomer represented by the formula (e) is also preferably a monomer represented by the formula: CF₂═CFORf-Z (wherein Rf and Z are as described above). Examples of monomers corresponding to this formula include the following monomers:

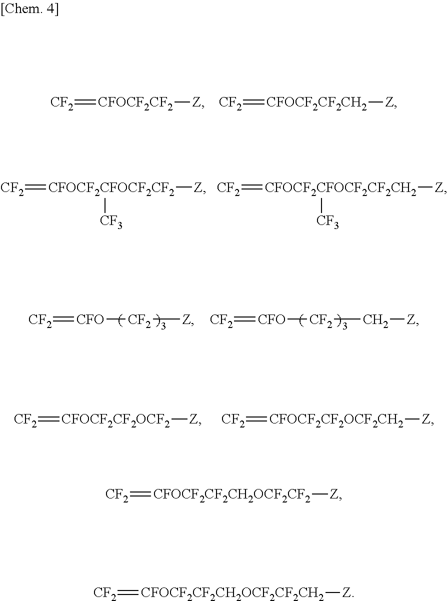

Examples of the monomer represented by the formula (e) also include the following monomers:

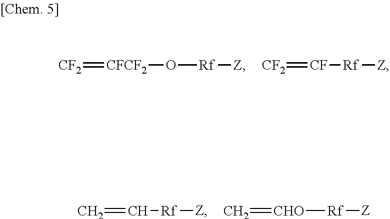

(wherein Rf and Z are as described above). Examples of monomers corresponding to these formulas include the following monomers:

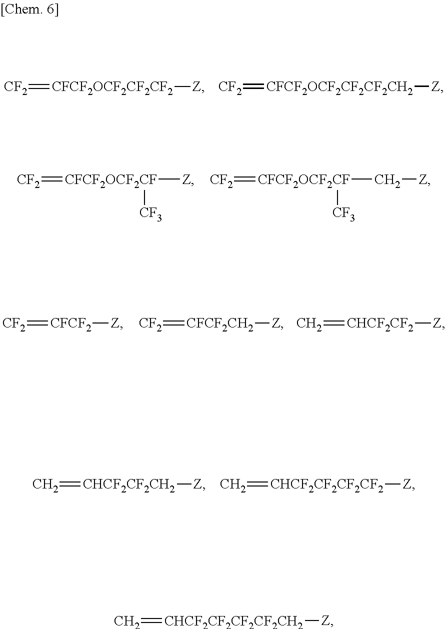

(wherein Z is as described above). Monomers containing a —OH group, a —COOH group, or a —SO₃H group may reduce electric properties and are therefore preferably present in an amount within the range that does not reduce electric properties.

Examples of the monomer represented by the formula (e) further include CH₂═CH—(CF₂)ₙF (n=1 to 10), CH₂═CF—CF₂—O—(CF(CF₃)—CF₂)ₙ—CF(CF₃) H (n=0 to 9), and the following monomers:

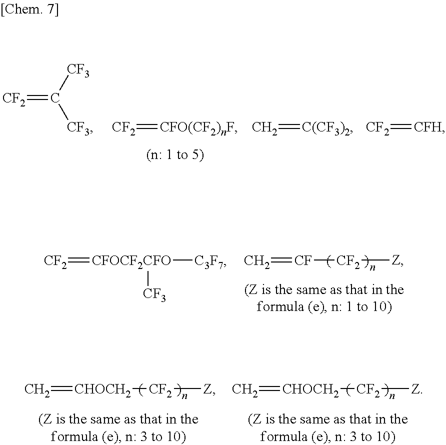

The monomer represented by the formula (e) is preferably CH₂═CF—CF₂—O—(CF(CF₃)—CF₂)ₙ—CF(CF₃)CH₂OH (wherein n=0 to 9), CH₂═CF—CF₂—O—(CF(CF₃)—CF₂)ₙ—CF(CF₃)COOH (wherein n=0 to 9), CH₂═CF—CF₂—O—(CF(CF₃)—CF₂)ₙ—CF(CF₃)CN (wherein n=0 to 9), CF₂═CF—O—(CF₂CF(CF₃O)ₙ—(CF₂)ₘ—Z (wherein Z is COOH, SO₃H or CN, m=1 to 6, and n=0 to 6), CF₂═CF₂, CF₂═CF—O—(CF₂)ₙF (n=1 to 5), CH₂═CF—CF₂—O—(CF(CF)—CF₂)ₙ—CF(CF₃) H (n=0 to 5), CH₂═CH—(CF₂)ₙF (n=1 to 6), or CF₂═CF—CF₃, more preferably CH₂═CH—C₆F₁₃ or CH₂═CF(CF₂OCFCF3)₂CH₂OH among those described above.

The high-fluorine-conversion cyclic olefin is a high-fluorine-conversion olefin with a cyclic structure. The high-fluorine-conversion cyclic olefin is not limited and may suitably be a monomer represented by the following formula (a) or (c):

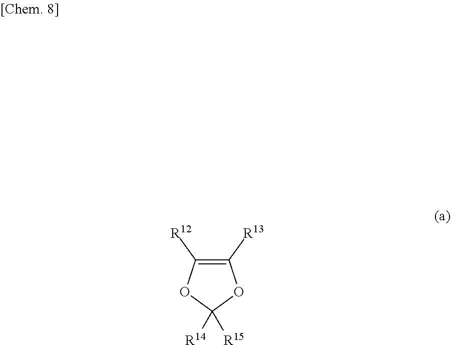

wherein R¹² to R¹⁵ are each independently a fluorine atom, a C1-C5 perfluoroalkyl group, or a C1-C5 perfluoroalkoxy group; or

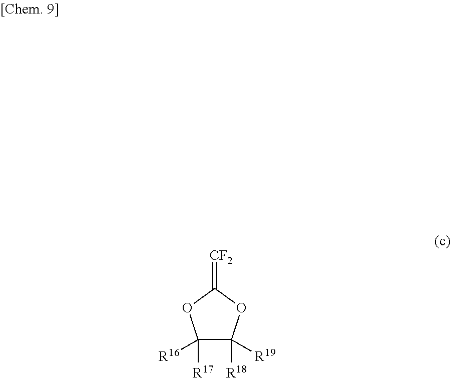

wherein R¹⁶ to R¹⁹ are each independently a fluorine atom, a C1-C5 perfluoroalkyl group, or a C1-C5 perfluoroalkoxy group.

Specific examples of the monomer represented by the formula (a) include monomers represented by the following formulas (a-1) to (a-5). Specific examples of the monomer represented by the formula (c) include monomers represented by the following formulas (a-6) and (a-7).

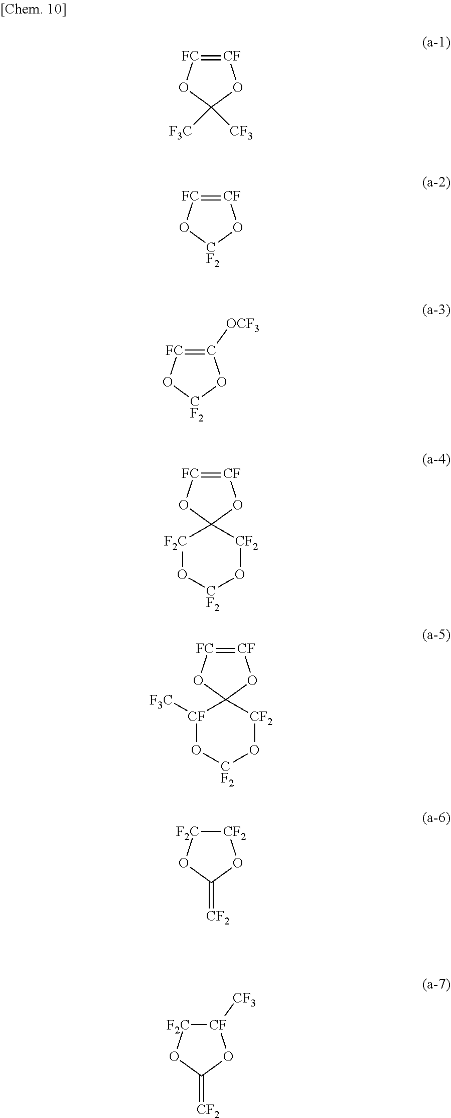

The high-fluorine-conversion monomer is preferably a cyclic high-fluorine-conversion olefin among those described above because of its good electric properties.

From the same point of view, the cyclic high-fluorine-conversion olefin is preferably a monomer represented by the formula (c), more preferably a monomer represented by the formula (a-6) or (a-7), still more preferably a monomer represented by the formula (a-7). In other words, preferably, three of R¹⁶ to R¹⁹ are fluorine atoms and one is a perfluoro methyl group in the formula (c).

In the step A, the solution containing a fluorinated monomer and a non-polymerizable solvent preferably further contains a monomer copolymerizable with the fluorinated monomer.

Examples of the monomer copolymerizable with the fluorinated monomer include a crosslinkable monomer and a fluorine-free monomer other than the crosslinkable monomer. Moreover, it may be a fluorine-containing monomer other than the high-fluorine-conversion monomer, specifically, a fluorine-containing monomer having a fluorine conversion FC of lower than 70%.

The crosslinkable monomer is preferably a multifunctional monomer containing two or more (in particular two to four) polymerizable reactive groups, in particular polymerizable double bonds. The presence of a multifunctional monomer allows the resulting hollow fine particulate to have improved strength.

Examples of the multifunctional monomer include di(meth)acrylates such as ethylene glycol di(meth)acrylate, diethylene glycol di(meth)acrylate, triethylene glycol di(meth)acrylate, 1,6-hexanediol di(meth)acrylate, and trimethylolpropane di(meth)acrylate; tri(meth)acrylates such as trimethylolpropane tri(meth)acrylate, ethylene oxide-modified trimethylolpropane tri(meth)acrylate, and pentaerythritol tri(meth)acrylate; diaryl compounds or triaryl compounds such as pentaerythritol tetra(meth)acrylate, dipentaerythritol hexa(meth)acrylate, diaryl phthalate, diaryl maleate, diaryl fumarate, diaryl succinate, and triaryl isocyanurate; divinyl compounds such as divinylbenzene, butadiene, 1,6-hexanediol divinyl ether, 1,4-butanediol divinyl ether, cyclohexanedimethanol divinyl ether, diethylene glycol divinyl ether, and triethylene glycol divinyl ether; di-α-fluoroacrylates such as ethylene glycol di-α-fluoroacrylate, diethylene glycol di-α-fluoroacrylate, triethylene glycol di-α-fluoroacrylate, 1,6-hexanediol di-α-fluoroacrylate, and trimethylolpropane di-α-fluoroacrylate; tri-α-fluoroacrylates such as trimethylolpropane tri-α-fluoroacrylate, ethylene oxide-modified trimethylolpropane tri-α-fluoroacrylate, and pentaerythritol tri-α-fluoroacrylate; tetra-α-fluoroacrylates such as pentaerythritol tetra-α-fluoroacrylate; and hexa-α-fluoroacrylates such as dipentaerythritol hexa-α-fluoroacrylate. One of these may be used alone or two or more of these may be used in the form of mixture. Preferred among these are divinyl ethers such as 1,4-butanediol divinyl ether, cyclohexanedimethanol divinyl ether, and diethylene glycol divinyl ether, and di(meth)acrylates such as ethylene glycol di(meth)acrylate and diethylene glycol di(meth)acrylate.

The multifunctional monomer is preferably a multifunctional high-fluorine-conversion monomer because it can lead to improved electric properties.

The multifunctional high-fluorine-conversion monomer is a monomer having a high fluorine conversion FC calculated by the above-described formula.

The fluorine conversion FC of the multifunctional high-fluorine-conversion monomer is preferably 50% or higher, more preferably 60% or higher, still more preferably 100%. In other words, the multifunctional high-fluorine-conversion monomer is preferably a multifunctional perfluoro monomer.

Examples of the multifunctional high-fluorine-conversion monomer include CH₂═CX—COO—CH₂ (CF₂CF₂)ₙCH₂—OCO—CX═CH₂ (wherein X is H, CH₃, F, or Cl, and n=2 to 10), CH₂═CX—COO—CH₂CF(CF₃)—O—(CF₂CF(CF₃)O)ₙCF(CF₃)CH₂—OCO—CX═CH₂ (wherein X is H, CH₃, F, or Cl, and n=1 to 20), CF₂═CF—O—(CF₂)ₙ—O—CF═CF₂ (wherein n=1 to 20), CF₂═CF—(CF₂)ₙ—O—CF═CF₂ (wherein n=1 to 20), CF₂═CF—(CF₂)ₘ—CF═CF₂ (wherein m=1 to 20), CF₂═CF—(O—CF₂CF(CF₃))ₙ—O—CF═CF₂ (wherein n=1 to 20), and CF₂═CF—(CF₂)ₙ—CF═CF₂ (wherein n=1 to 20). Of these, CF₂═CF—O—(CF₂)ₙ—O—CF═CF₂ (wherein n=1 to 20), CF₂═CF—(CF₂)ₙ—O—CF═CF₂ (wherein n=1 to 20), and CF₂═CF—(CF₂)ₘ—CF═CF₂ (wherein m=1 to 20) are preferred, CF₂═CF—O—(CF₂)ₙ—O—CF═CF₂ (wherein n=1 to 20) is more preferred, CF₂═CF—O—(CF₂)ₙ—O—CF═CF₂ (wherein n=1 to 5) is still more preferred, and CF₂═CF—O—(CF₂)₃—O—CF═CF₂ is particularly preferred.

Examples of the fluorine-free monomer other than the crosslinkable monomer include, but are not limited to, a monofunctional monomer that does not contain a fluorine atom and contains one polymerizable reactive group.

Examples of the monofunctional monomer include alkyl (meth)acrylates such as methyl (meth)acrylate, ethyl (meth)acrylate, propyl (meth)acrylate, butyl (meth)acrylate, cumyl (meth)acrylate, cyclohexyl (meth)acrylate, myristyl (meth)acrylate, palmityl (meth)acrylate, stearyl (meth)acrylate, lauryl (meth)acrylate, and isobornyl (meth)acrylate; polar group-containing (meth)acrylic monomers such as (meth)acrylonitrile, (meth)acrylamide, (meth)acrylic acid, glycidyl (meth)acrylate, 2-hydroxyethyl methacrylate, and 2-hydroxypropyl methacrylate; aromatic vinyl monomers such as styrene, α-methylstyrene, p-methylstyrene, and p-chlorostyrene; vinyl esters such as vinyl acetate, vinyl benzoate, vinyl ester of neononanoic acid (trade name VeoVa 9), vinyl ester of neodecanoic acid (trade name VeoVa 10), and vinyl propionate; vinyl ethers such as methyl vinyl ether, ethyl vinyl ether, butyl vinyl ether, and hydroxybutyl vinyl ether; halogen-containing monomers such as vinyl chloride and vinylidene chloride; vinylpyridine, 2-acryloyloxyethyl phthalic acid, itaconic acid, fumaric acid, ethylene, propylene, and a polydimethylsiloxane macromonomer. Preferred among these is at least one selected from the group consisting of methyl methacrylate, 2-hydroxyethyl methacrylate, cyclohexyl methacrylate, and isobornyl methacrylate from the viewpoints of miscibility with a high-fluorine-conversion monomer and an increase in the glass transition temperature (Tg).

The fluorine-containing monomer other than the high-fluorine-conversion monomer may be any fluorinated monomer having a fluorine conversion FC of lower than 70%. Examples include fluorine-containing acrylic monomers, fluorine-containing styrenic monomers, and fluorine-containing olefins.

In the step A, the solution containing a fluorinated monomer and a non-polymerizable solvent contains the monomer in an amount of 0.1 to 10 parts by mass, more preferably 0.5 to 5 parts by mass, still more preferably 0.8 to 3.5 parts by mass, relative to 1 part by mass of the non-polymerizable solvent.

In the case where a fluorinated monomer alone is polymerized, the amount of the monomer(s) contained means the amount of the fluorinated monomer used. In the case where a fluorinated monomer and a monomer copolymerizable with the fluorinated monomer are polymerized, the amount of the monomer(s) contained means the sum of the amounts of the fluorinated monomer and the monomer copolymerizable with the fluorinated monomer. The proportion of each monomer may be set as appropriate in accordance with the target fluorine-containing resin.

The non-polymerizable solvent used is a solvent that can dissolve a fluorinated monomer and the like and has low miscibility with the resulting fluorine-containing resin. Low miscibility with the resulting fluorine-containing resin can promote phase separation of the resulting fluorine-containing resin, which enables production of a hollow fine particulate.

The non-polymerizable solvent is preferably a solvent that can dissolve a fluorinated monomer and the like and does not dissolve the resulting fluorine-containing resin.

The non-polymerizable solvent used is a solvent that has a low miscibility with the fluorine-containing resin and satisfies the relationship γ^{X}≥γ^{P}, wherein γ^{X} represents the interfacial tension between the non-polymerizable solvent and water, and γ^{P} represents the interfacial tension (mN/m) between water and a surface that adsorbs a polymer obtained by polymerization in the step (B).

The non-polymerizable solvent is preferably, for example, one that is in the form of liquid at the polymerization temperature of a fluorine-containing monomer, is mixable with the monomer(s), is unreactive with the monomer(s), and is easily evaporated by heating or the like. Examples include an aromatic hydrocarbon, an ester, and a saturated hydrocarbon or halogen-substituted product thereof.

Examples of the saturated hydrocarbon or halogen-substituted product thereof include butane, pentane, hexane, hexadecane, cyclohexane, decane, methyl chloride, methylene chloride, chloroform, carbon tetrachloride, bromonaphthalene, and dichloromethane.

Examples of the aromatic hydrocarbon include toluene, xylene, benzene, and chlorobenzene.

Examples of the ester include ethyl acetate and butyl acetate.

In view of the ability to dissolve the fluorinated monomer, the non-polymerizable solvent is preferably a fluorine-containing non-polymerizable solvent.

The fluorine-containing non-polymerizable solvent preferably includes at least one selected from the group consisting of a perfluoro aromatic compound, a perfluorotrialkylamine, a perfluoroalkane, a hydrofluorocarbon, a perfluoro cyclic ether, and a hydrofluoroether.

The perfluoro aromatic compound is, for example, a perfluoro aromatic compound optionally containing one or more perfluoroalkyl groups. The aromatic ring of the perfluoro aromatic compound may include at least one ring selected from the group consisting of a benzene ring, a naphthalene ring, and an anthracene ring. The perfluoro aromatic compound may contain one or more (e.g., one, two, or three) aromatic rings. The perfluoroalkyl group as a substituent may be, for example, a C1-C6, C1-C5, or C1-C4 linear or branched perfluoroalkyl group, and is preferably a C1-C3 linear or branched perfluoroalkyl group. The number of substituents may be, for example, 1 to 4, preferably 1 to 3, more preferably 1 or 2. In the case where multiple substituents are present, they may be the same as or different from each other. Examples of the perfluoro aromatic compound include perfluorobenzene, perfluorotoluene, perfluoroxylene, and perfluoronaphthalene. Preferred examples of the perfluoro aromatic compound include perfluorobenzene and perfluorotoluene.

The perfluorotrialkylamine may be, for example, an amine substituted with three linear or branched perfluoroalkyl groups. The perfluoroalkyl group may have a carbon number of, for example, 1 to 10, preferably 1 to 5, more preferably 1 to 4. The perfluoroalkyl groups may be the same as or different from each other, and are preferably the same as each other. Examples of the perfluorotrialkylamine include perfluorotrimetylamine, perfluorotrietoylamine, perfluorotripropylamine, perfluorotriisopropylamine, perfluorotributylamine, perfluoro tri-sec-butylamine, perfluoro tri-tert-butylamine, perfluorotripentylamine, perfluorotriisopentylamine, and perfluorotrineopentylamine. Preferred is perfluorotripropylamine or perfluorotributylamine.

The perfluoroalkane may be, for example, a C3-C12 (preferably C3-C10, more preferably C3-C6) linear, branched, or cyclic perfluoroalkane. Examples of the perfluoroalkane include perfluoropentane, perfluoro-2-methylpentane, perfluorohexane, perfluoro-2-methyl hexane, perfluoroheptane, perfluorooctane, perfluorononane, perfluorodecane, perfluorocyclohexane, perfluoro(methylcyclohexane), perfluoro(dimethylcyclohexane) (e.g., perfluoro(1,3-dimethylcyclohexane)), and perfluorodecalin. Preferred is perfluoropentane, perfluorohexane, perfluoroheptane, or perfluorooctane.

The hydrofluorocarbon may be, for example, a C3-C8 hydrofluorocarbon. Examples of the hydrofluorocarbon include CF₃CH₂CF₂H, CF₃CH₂CF₂CH₃, CF₃CHFCHFC₂F₅, 1,1,2,2,3,3,4-heptafluorocyclopentane, CF₃CF₂CF₂CF₂CH₂CH₃, CF₃CF₂CF₂CF₂CF₂CHF₂, and CF₃CF₂CF₂CF₂CF₂CF₂CH₂CH₃. Preferred is CF₃CH₂CF₂H, CF₃CH₂CF₂CH₃, or 1,1,2,2,3,3,4-heptafluorocyclopentane, with 1,1,2,2,3,3,4-heptafluorocyclopentane being more preferred.

The perfluoro cyclic ether may be, for example, a perfluoro cyclic ether optionally containing one or more perfluoroalkyl groups. The ring of the perfluoro cyclic ether may be a 3- to 6-membered ring. The ring of the perfluoro cyclic ether may optionally contain one or more oxygen atoms as ring-constituting atoms. The ring preferably contains one or two oxygen atoms, more preferably one oxygen atom. The perfluoroalkyl group as a substituent may be, for example, a C1-C6, C1-C5, or C1-C4 linear or branched perfluoroalkyl group. A preferred perfluoroalkyl group is a C1-C3 linear or branched perfluoroalkyl group. The number of substituents may be, for example, 1 to 4, preferably 1 to 3, more preferably 1 or 2. In the case where multiple substituents are present, they may be the same as or different from each other. Examples of the perfluoro cyclic ether include perfluorotetrahydrofuran, perfluoro-5-methyltetrahydrofuran, perfluoro-5-ethyltetrahydrofuran, perfluoro-5-propyltetrahydrofuran, perfluoro-5-butyltetrahydrofuran, and perfluorotetrahydropyran. Preferred examples of the perfluoro cyclic ether include perfluoro-5-ethyltetrahydrofuran and perfluoro-5-butyltetrahydrofuran.

The hydrofluoroether may be, for example, a fluorine-containing ether. The hydrofluoroether preferably has a global warming potential (GWP) of 400 or lower, more preferably 300 or lower. Examples of the hydrofluoroether include CF₃CF₂CF₂CF₂OCH₃, CF₃CF₂CF(CF₃) OCH₃, CF₃CF(CF₃)CF₂OCH₃, CF₃CF₂CF₂CF₂OC₂H₅, CF₃CH₂OCF₂CHF₂, C₂F₅CF(OCH₃)C₃F₇, trifluoromethyl 1,2,2,2-tetrafluoroethyl ether (HFE-227me), difluoromethyl 1,1,2,2,2-pentafluoroethyl ether (HFE-227mc), trifluoromethyl 1,1,2,2-tetrafluoroethyl ether (HFE-227pc), difluoromethyl 2,2,2-trifluoroethyl ether (HFE-245mf), and 2,2-difluoroethyl trifluoromethyl ether (HFE-245pf). The hydrofluoroether is preferably CF₃CH₂OCF₂CHF₂, C₂F₅CF(OCH₃)C₃F₇, or a compound represented by the following formula (Dl):

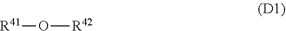

(wherein R⁴¹ is linear or branched perfluorobutyl; and R⁴² is methyl or ethyl) such as CF₃CF₂CF₂CF₂OCH₃ or CF₃CF₂CF₂CF₂OC₂H5, more preferably a compound represented by the formula (Dl).

Preferably, the non-polymerizable fluorine-containing solvent preferably has high ability to dissolve the fluorinated monomer and has low ability to dissolve a fluorine-containing resin which is a polymer of the fluorinated monomer. From this point of view, the non-polymerizable fluorine-containing solvent preferably contains hydrogen and fluorine.

The non-polymerizable fluorine-containing solvent is preferably at least one selected from the group consisting of a C3-C8 hydrofluorocarbon, a C1-C5 fluorine-containing alcohol, and a C3-C8 hydrofluoroether.

The production method of the disclosure allows the resulting hollow fine particulate to have either of a monoporous structure or a multiporous structure in accordance with the type of the non-polymerizable solvent. The reason why a multiporous structure is formed or a monoporous structure is formed is not clear. Still, with regard to the combination of the obtained fluorine-containing resin and the solvent, a monoporous structure is formed in a completely non-miscible system while a multiporous structure is formed in a slightly miscible system.

The completely non-miscible system refers to any system in which the fluorine-containing resin obtained shows no visually observable swelling after it is placed in a non-polymerizable solvent at a concentration of 5% by mass and at the polymerization temperature for six hours. For example, use of a saturated hydrocarbon as a non-polymerizable solvent can provide a hollow fine particulate having a monoporous structure.

The non-polymerizable solvent may be used in an amount selected as appropriate within a wide range, and is commonly 0.1 to 10 parts by mass, preferably 0.5 to 5 parts by mass, relative to 1 part by mass of the monomer(s).

In the step A, the dispersion preferably contains a particle dispersion stabilizer. The presence of a particulate dispersion stabilizer can further promote phase separation and lead to a hollow fine particulate having a large particle size.

The particulate dispersion stabilizer may be preliminarily mixed with water before the step A or may be preliminarily mixed with the solution containing the fluorinated monomer and the non-polymerizable solvent before the step A. Alternatively, it may be added to water separately from the solution in the step A.

The particulate dispersion stabilizer used may be selected from a wide range of those having an effect of preventing aggregation of droplets formed by dispersing a solution containing a monomer component, a phase separation promoter, and a non-polymerizable solvent in water.

Examples include high molecular weight dispersion stabilizers such as polyvinyl alcohol, methyl cellulose, ethyl cellulose, polyacrylic acid, polymethacrylic acid, polyacrylimide, polyethylene oxide, polyvinyl pyrrolidone, and a poly(hydroxystearic acid-g-methyl methacrylate-co-methacrylic acid) copolymer; and a fluorine-containing particulate dispersion stabilizer. A fluorine-containing particulate dispersion stabilizer is preferred among these.

Examples of the fluorine-containing particulate dispersion stabilizer include a fluoropolymer (α) of a monomer (α) represented by the general formula (α):

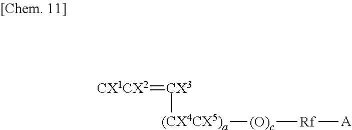

wherein X¹, X², X³, X⁴ and X⁵ are each independently H, F, CH₃, or CF₃, and at least one of X¹, X², X³, X⁴ and X⁵ is F; a and c are the same as or different from each other and each independently 0 or 1; Rf is a C1-C40 fluorine-containing alkylene group, a C2-C100 fluorine-containing alkylene group containing an ether bond, or a C2-C100 fluorine-containing alkylene group containing a keto group; A is —COOM, —SO₃M, —OSO₃M, or —C(CF₃)₂OM (wherein M is H, a metal atom, NR⁷₄, an optionally substituted imidazolium, an optionally substituted pyridinium, or an optionally substituted phosphonium; and R⁷ is H or an organic group).

When a is 1, c is preferably 1; X¹ and X² are preferably each independently H or F, more preferably H; and X³, X⁴ and X⁵ are preferably each independently H or F, preferably F. When a is 0, c is preferably 1; X¹ and X² are preferably each independently H or F, more preferably F; and X³, X⁴ and X⁵ are preferably each independently H or F, preferably F.

Specifically, the monomer (α) is preferably at least one selected from the formula (1a): CF₂═CF—O—Rf-A and the formula (2a): CH₂═CF—CF₂—O—Rf-A because such a monomer (α) further improves the water solubility of the fluoropolymer.

When Rf in the formula is a C2-C100 fluorine-containing alkylene group containing an ether bond, it is an alkylene group that does not have an oxygen atom at its terminal and contains an ether bond between carbon atoms.

The carbon number of the fluorine-containing alkylene group is preferably 2 or more. The carbon number of the fluorine-containing alkylene group is preferably 30 or less, more preferably 20 or less, still more preferably 10 or less, particularly preferably 6 or less, most preferably 3 or less. Examples of the fluorine-containing alkylene group include —CF₂—, —CH₂CF₂—, —CF₂CF₂—, —CF₂CF₂CF₂—, —CF₂CH₂—, —CF₂CF₂CH₂—, —CF(CF₃)—, —CF(CF₃)CF₂—, and —CF(CF₃)CH₂—. The fluorine-containing alkylene group is preferably a perfluoroalkylene group.

When a is 1, the fluorine-containing alkylene group is preferably a branched perfluoroalkylene group. When a is 0, the fluorine-containing alkylene group is preferably an unbranched linear perfluoroalkylene group.

The carbon number of the fluorine-containing alkylene group containing an ether bond is preferably 3 or more. The carbon number of the fluorine-containing alkylene group containing an ether bond is preferably 60 or less, more preferably 30 or less, still more preferably 12 or less, particularly preferably 9 or less, most preferably 6 or less. The fluorine-containing alkylene group containing an ether bond is also preferably a divalent group represented by the general formula:

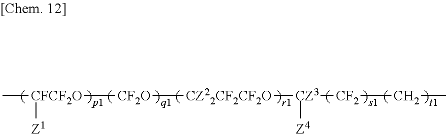

wherein Z¹ is F or CF₃; Z² and Z³ are each independently H or F; Z⁴ is H, F, or CF₃; p1+q1+r1 is an integer of 1 to 10; s1 is 0 or 1; and t1 is an integer of 0 to 5.

Specific examples of the fluorine-containing alkylene group containing an ether bond include —CF₂CF(CF₃) OCF₂CF₂—, —CF(CF₃)CF₂—O—CF(CF₃)—, —(CF(CF₃)CF₂—O)ₙ—CF(CF₃)— (wherein n is an integer of 1 to 10), —CF(CF₃)CF₂—O—CF(CF₃)CH₂—, —(CF(CF₃)CF₂—O)ₙ—CF(CF₃)CH₂— (wherein n is an integer of 1 to 10), —CH₂CF₂CF₂O—CH₂CF₂CH₂—, —CF₂CF₂CF₂O—CF₂—, —CF₂CF₂CF₂O—CF₂CF₂—, —CF₂CF₂CF₂O—CF₂CF₂CF₂—, —CF₂CF₂CF₂O—CF₂CF₂CH₂—, —CF₂CF₂O—CF₂—, and —CF₂CF₂O—CF₂CH₂—. The fluorine-containing alkylene group containing an ether bond is preferably a perfluoroalkylene group.

The carbon number of the fluorine-containing alkylene group containing a keto group is preferably 3 or more. The carbon number of the fluorine-containing alkylene group containing a keto group is preferably 60 or less, more preferably 30 or less, still more preferably 12 or less, particularly preferably 5 or less.

Specific examples of the fluorine-containing alkylene group containing a keto group include —CF₂CF(CF₃)CO—CF₂—, —CF₂CF(CF₃)CO—CF₂CF₂—, —CF₂CF(CF₃)CO—CF₂CF₂CF₂—, and —CF₂CF(CF₃)CO—CF₂CF₂CF₂CF₂—. The fluorine-containing alkylene group containing a keto group is preferably a perfluoroalkylene group.

Water may be added to the keto group in the fluorine-containing alkylene group. Thus, the monomer (ca) may be a hydrate. Examples of the fluorine-containing alkylene group containing a water-added keto group include —CF₂CF(CF₃)C(OH)₂—CF₂—, —CF₂CF(CF₃)C(OH)₂—CF₂CF₂—, —CF₂CF(CF₃)C(OH)₂—CF₂CF₂CF₂—, and —CF₂CF(CF₃)C(OH)₂—CF₂CF₂CF₂CF₂—.

In the formula, A is —COOM, —SO₃M, —OSO₃M, or —C(CF₃)₂OM, preferably —COOM or —SO₃M, more preferably —COOM.

M is H, a metal atom, NR⁷₄, an optionally substituted imidazolium, an optionally substituted pyridinium, or an optionally substituted phosphonium. R⁷ is H or an organic group.

Examples of the metal atom include an alkali metal (Group 1) and an alkaline earth metal (Group 2). The metal atom is preferably Na, K, or Li.

M is preferably H, a metal atom, or NR⁷₄, more preferably H, an alkali metal (Group 1), an alkaline earth metal (Group 2), or NR⁷₄, still more preferably H, Na, K, Li, or NH₄, further preferably H, Na, K, or NH₄, most preferably H, Na, or NH₄.

Examples of the CF₂═CF—O—Rf-A (formula (1a)) include CF₂═CFOCF₂COOM, CF₂═CFOCF₂CF₂COOM, CF₂═CFO(CF₂)₃COOM, CF₂═CFOCF₂CF₂SO₃M, CF₂═CFOCF₂SO₃M, CF₂═CFOCF₂CF₂CF₂SO₃M, CF₂═CFOCF₂CF(CF₃) OCF₂CF₂COOM, CF₂═CFOCF₂CF(CF₃) OCF₂COOM, CF₂═CFOCF₂CF(CF₃) OCF₂CF₂CF₂COOM, CF₂═CFOCF₂CF(CF₃) OCF₂SO₃M, CF₂═CFOCF₂CF(CF₃) OCF₂CF₂SO₃M, and CF₂═CFOCF₂CF(CF₃) OCF₂CF₂CF₂SO₃M (wherein M is H, NH₄, or an alkali metal).

Preferred among these are CF₂═CFOCF₂COOM, CF₂═CFOCF₂CF₂COOM, CF₂═CFO(CF₂)₃COOM, CF₂═CFOCF₂CF₂SO₃M, CF₂═CFOCF₂SO₃M, CF₂═CFOCF₂CF₂CF₂SO₃M, and CH₂═CFCF₂OCF(CF₃)COOM (wherein M is H, NH₄, or an alkali metal).

Preferred examples of the CH₂═CF—CF₂—O—Rf-A (formula (2a)) include

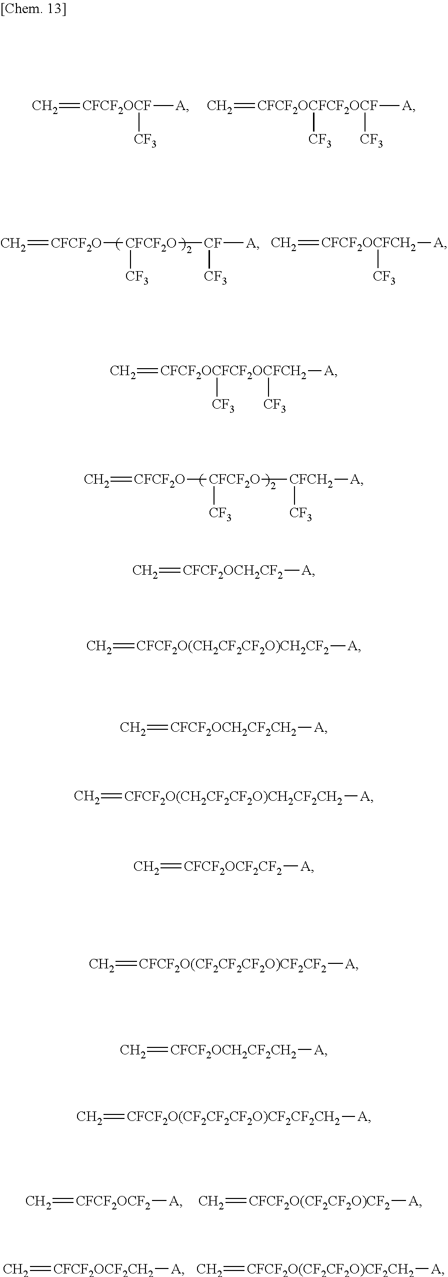

Of these,

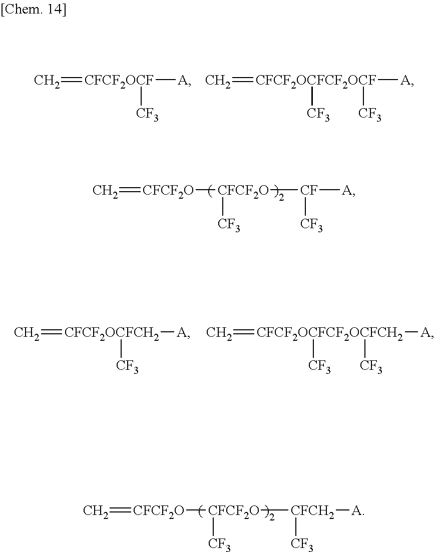

are preferred.

The monomer represented by the general formula (2a) is preferably a monomer of the formula (2a) in which A is —COOM. In particular, it is preferably at least one selected from the group consisting of CH₂═CFCF₂OCF(CF₃)COOM and CH₂═CFCF₂OCF(CF₃)CF₂OCF(CF₃)COOM (wherein M is as defined above), more preferably CH₂═CFCF₂OCF(CF₃)COOM.

The monomer (α) may be copolymerized with a different monomer. Specifically, the fluoropolymer (α) may be a homopolymer of the monomer represented by the general formula (α) or may be a copolymer with a different monomer. The fluoropolymer (α) may contain a polymerized unit (α) based on two or more different monomers represented by the general formula (α).

The different monomer is preferably a monomer represented by the general formula CFR═CR₂ (wherein Rs are each independently H, F, or a C1-C4 perfluoroalkyl group). The different monomer is preferably a C2 or C3 fluorine-containing ethylenic monomer. Examples of the different monomer include CF₂═CF₂, CF₂═CFCl, CH₂═CF₂, CFH═CH₂, CFH═CF₂, CF₂═CFCF₃, CH₂═CFCF₃, CH₂═CHCF₃, CHF═CHCF₃ (E isomer), and CHF═CHCF₃ (Z isomer).

The different monomer is preferably at least one selected from the group consisting of tetrafluoroethylene (CF₂═CF₂), chlorotrifluoroethylene (CF₂═CFCl), and hexafluoropropylene (CF₂═CFCF₃) because they are well copolymerizable, more preferably tetrafluoroethylene. Thus, the polymerized unit based on the different monomer is preferably a polymerized unit based on tetrafluoroethylene. Expressed polymerized units based on the different monomers may be the same as or different from each other. The fluoropolymer may contain polymerized units based on two or more different monomers.

Examples of the different monomer also include monomers represented by the general formula (n1-2):

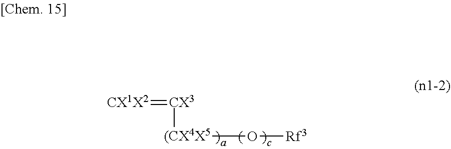

wherein X¹ and X² are the same as or different from each other and are each independently H or F; X³ is H, F, Cl, CH₃ or CF₃; X⁴ and X⁵ are the same as or different from each other and are each independently H or F; a and c are the same as or different from each other and are each independently 0 or 1; and Rf³ is a C1-C40 fluorine-containing alkyl group or a C2-C100 fluorine-containing alkyl group containing an ether bond.

Specific examples include CH₂═CFCF₂—O—Rf³, CF₂═CF—O—Rf³, CF₂═C FCF₂—O—Rf³, CF₂═CF—Rf³, CH₂═CH—Rf³, and CH₂═CH—O—Rf³ (wherein Rf³ is as described for the formula (nl-2)).

The fluoropolymer (β) contains the polymerized unit (3) in an amount, in order of preference with the latter being more preferred, of 50 mol % or more, 60 mol % or more, 70 mol % or more, 80 mol % or more, 90 mol % or more, or 99 mol % or more, of all polymerized units. Particularly preferably, the amount of the polymerized unit (β) is substantially 100%. Most preferably, the fluoropolymer (β) consists only of the polymerized unit (β). The fluoropolymer (β) containing a larger amount of the polymerized unit (β) advantageously has a higher water solubility.

The fluoropolymer (β) contains a polymerized unit based on a different monomer copolymerizable with the monomer (β) in an amount, in order of preference with the latter being more preferred, of 50 mol % or less, 40 mol % or less, 30 mol % or less, 20 mol % or less, 10 mol % or less, or 1 mol % or less, of all polymerized units. Particularly preferably, the amount of the polymerized unit based on a different monomer copolymerizable with the monomer (β) is substantially 0 mol %. Most preferably, the fluoropolymer (β) does not contain a polymerized unit based on the different monomer.

The lower limit of the weight average molecular weight (Mw) of the fluoropolymer (β) is, in order of preference with the latter being more preferred, 1.4×10⁴ or more, 1.7×10⁴ or more, 1.9×10⁴ or more, 2.1×10⁴ or more, 2.3×10⁴ or more, 2.7×10⁴ or more, 3.1×10⁴ or more, 3.5×10⁴ or more, 3.9×10⁴ or more, 4.3×10⁴ or more, 4.7×10⁴ or more, or 5.1×10⁴ or more. The upper limit of the weight average molecular weight (Mw) of the fluoropolymer is, in order of preference with the latter being more preferred, 150.0×10⁴ or less, 100.0×10⁴ or less, 60.0×10⁴ or less, or 50.0×10⁴ or less.

The lower limit of the number average molecular weight (Mn) of the fluoropolymer (β) is, in order of preference with the latter being more preferred, 0.7×10⁴ or more, 0.9×10⁴ or more, 1.0×10⁴ or more, 1.2×10⁴ or more, 1.4×10⁴ or more, 1.6×10⁴ or more, or 1.8×10⁴ or more. The upper limit of the number average molecular weight (Mn) of the fluoropolymer is, in order of preference with the latter being more preferred, 75.0×10⁴ or less, 50.0×10⁴ or less, 40.0×10⁴ or less, 30.0×10⁴, or 20.0×10⁴ or less.

The molecular weight distribution (Mw/Mn) of the fluoropolymer (β) is preferably 3.0 or less, more preferably 2.4 or less, still more preferably 2.2 or less, particularly preferably 2.0 or less, most preferably 1.9 or less.

The fluoropolymer (β) usually has terminal groups. The terminal groups are generated during polymerization. Typical terminal groups are independently selected from hydrogen, iodine, bromine, a linear or branched alkyl group, and a linear or branched fluoroalkyl group and may optionally further contain at least one catenary heteroatom. The alkyl group and the fluoroalkyl group each preferably have 1 to 20 carbon atoms. The terminal groups are generally generated from an initiator or a chain transfer agent used in the formation of the fluoropolymer (β) or generated during a chain transfer reaction.

Examples of the fluorine-containing particulate dispersion stabilizer also include an anionic fluorine-containing surfactant. Examples of the anionic fluorine-containing surfactant include surfactants represented by the formula (1):

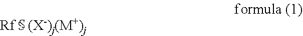

wherein Rf [symbol] is a C1-C30 (per)fluoroalkyl chain or a (per) fluoro(poly)oxyalkylene chain; X⁻ is —COO—, —PO₃—, or —SO₃—; M⁺ is selected from H⁺, NH₄⁺, and an alkali metal ion; and j may be 1 or 2.

Specific examples of the anionic fluorine-containing surfactant include ammonium (per)fluoro(oxy)carboxylate, sodium ammonium (per)fluoro(oxy)carboxylate, and (per)fluoro(poly)oxyalkylene having one or more carboxyl terminal group(s).

Examples of the fluorine-containing surfactant, particularly the (per)fluorooxyalkylene surfactant, are described in U.S. Patent Application Publication No. 2007/0015864 (3M Innovative Properties Co.) Jan. 8, 2007, U.S. Patent Application Publication No. 2007/0015865 (3M Innovative Properties Co.) Jan. 18, 2007, U.S. Patent Application Publication No. 2007/0015866 (3M Innovative Properties Co.) Jan. 18, 2007, and U.S. Patent Application Publication No. 2007/0025902 (3M Innovative Properties Co.) Feb. 1, 2007.

The fluorine-containing particulate dispersion stabilizer may be a fluorine-containing surfactant with a molecular weight of an anionic portion of 800 or less. The term “anionic portion” refers to a portion excluding cations in the anionic fluorine-containing surfactant. The anionic portion in the formula (1) is the “Rf§ (X⁻)j” portion.

The particulate dispersion stabilizer is preferably a fluorine-containing particulate dispersion stabilizer among those described above, such as fluoropolymers of the monomers represented by the following formulas wherein M is H, NH₄ or an alkali metal:

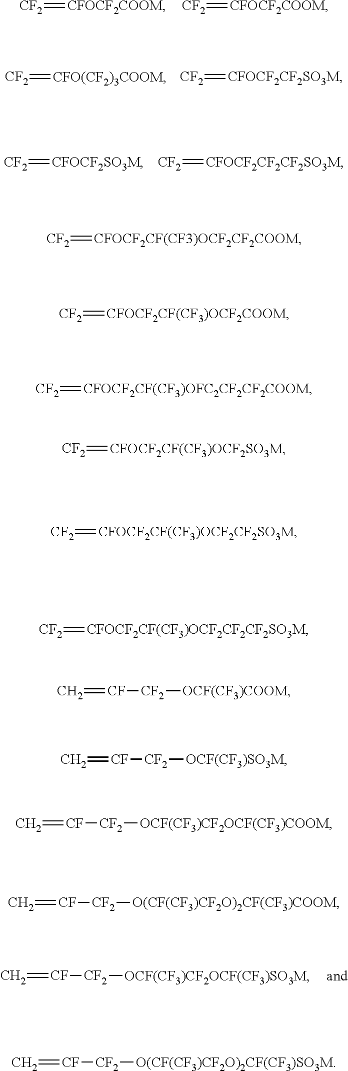

In particular, preferred monomers are CF₂═CFOCF₂COOM, CF₂═CFOCF₂CF₂COOM, CF₂═CFO(CF₂)₃COOM, CF₂═CFOCF₂CF₂SO₃M, CF₂═CFOCF₂SO₃M, CF₂═CFOCF₂CF₂CF₂SO₃M, CH₂═CFCF₂OCF(CF₃)COOM, and CH₂═C FCF₂OCF(CF₃)CF₂OCF(CF₃)COOM.

The amount of the particulate dispersion stabilizer per one part by mass of the solution is preferably 0.005 to 10 parts by mass, more preferably 0.01 to 5 parts by mass.

In the step A, the phase separation promoter content of the solution is preferably as small as possible for better electric properties. The phase separation promoter content in one part by mass of the solution is preferably 0.005 parts by mass or lower, more preferably 0.001 parts by mass or lower. The lower limit is not limited and may be 0 parts by mass.

Examples of usable phase separation promoters include a compound that is dissolvable in a non-polymerizable solvent at room temperature (e.g., 25° C.) and that satisfies the relationship of the following formula:

$$\vert SA - SB \vert < 3 {( J / {cm}^{3} )}^{1 / 2}$$

wherein SA represents the Sp value (J/cm³)^{1/2} of the phase separation promoter and SB represents the Sp value (J/cm³)^{1/2} of the non-polymerizable solvent.

Specific examples include an aromatic vinyl polymer, a polyalkyl (meth)acrylate, a vinyl chloride polymer, polyvinyl acetate, and polyester.

The step A is a step of dispersing in water a solution containing a fluorinated monomer, a non-polymerizable solvent, and optional components such as a monomer copolymerizable with the fluorinated monomer, an initiator, and a dispersion stabilizer to obtain a dispersion.

The dispersing may be performed by, for example, a variety of known methods such as dispersing by mechanical shearing force using a homogenizer or employing membrane emulsification. The dispersing may be performed under a temperature condition of 0° C. or higher and lower than 100° C., preferably 0° C. to 90° C. In the case where the solution in the dispersing contains an initiator, the temperature needs to be not higher than the temperature that affects decomposition of the initiator used, and is typically around room temperature or lower, particularly preferably about 0° C. to about 30° C.

In the step A, usually, droplets formed by dispersion of the solution are not monodispersed but are commonly in the form of mixture of droplets having various, different particle sizes. Thus, particles of a hollow fine particulate finally obtained also have different particle sizes.

Alternatively, a dispersion method may be selected so as to achieve droplets of a uniform size and provide monodispersed droplets. An exemplary method for forming such monodispersed droplets is a method of producing monodispersed droplets by membrane emulsification using porous glass (SPG). In the case of producing such monodispersed droplets having a uniform particle size, particles of a hollow fine particulate finally obtained are also monodispersed with a uniform particle size.

In either case, the average particle size of the droplets is determined as appropriate in accordance with a desired average particle size of the hollow fine particulate.

The step A also preferably includes a dispersing step A-1 in which the solution is dispersed in water at a temperature of 50° C. or higher (preferably 55° C. or higher, more preferably 60° C. or higher, still more preferably 65° C. or higher) to provide a dispersion or a dispersing step A-2 in which the solution is dispersed in water at a temperature of lower than 50° C. to obtain a dispersion and then the dispersion is heated to 50° C. or higher (preferably 55° C. or higher, more preferably 60° C. or higher, still more preferably 65° C. or higher).

The upper limit of the temperature in both the steps A-1 and A-2 is preferably 100° C. or lower, more preferably 95° C. or lower, still more preferably 90° C. or lower.

These steps each enable efficient progress of polymerization without phase separation of the dispersion even when the fluorinated monomer is used.

Preferably, a polymerization initiator is used in the production method of the disclosure. The polymerization initiator may be added to the solution before the step A or may be added to the dispersion after the step A and before the step B. In the case where the dispersing is performed at a relatively high temperature (e.g., 50° C. or higher) as described above and the polymerization initiator is added to the solution before the step A, polymerization may undesirably start in the step A. Therefore, the polymerization initiator is preferably added to the dispersion after the step A and before the step B. This allows the step A to be performed at a relatively high temperature.

The polymerization initiator initiates polymerization of a monomer in droplets formed by dispersing the solution in water. Conventional polymerization initiators such as oil-soluble initiators are usable. Examples include radical polymerization initiators, for example, azo compounds such as azobisisobutyronitrile, 2,2′-azobis(2-methylbutyronitrile), 2,2′-azobis(4-methoxy-2,4-dimethylvaleronitrile), and 2,2′-azobis(N-butyl-2-methylpropionamide), and peroxides such as cumene hydroperoxide, t-butyl hydroperoxide, dicumyl peroxide, di-t-butyl peroxide, benzoyl peroxide, and lauroyl peroxide.

A photopolymerization initiator that initiates polymerization by light, such as ultraviolet rays, is also usable. The photopolymerization initiator may be, but not limited to, a conventionally used one.

Examples of the polymerization initiator also include compounds represented by the following formulas (C1), (C2), and (C3) (herein, also referred to as “compound (C1)”, “compound (C2)”, and “compound (C3)”, respectively) and inorganic peroxides. The compound (C1) to the compound (C3) and the inorganic peroxides may each be used alone or may be used in combination.

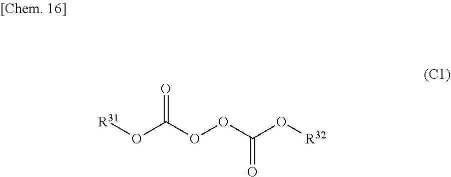

In the formula, R³¹ and R³² may be the same as or different from each other and each independently a group obtained by replacing at least one fluorine atom with a hydrogen atom in a C3-C10 perfluoroalkyl group optionally substituted with perfluorophenyl or a group obtained by replacing at least one fluorine atom with a hydrogen atom in perfluorophenyl optionally substituted with a linear or branched C1-C4 perfluoroalkyl group.

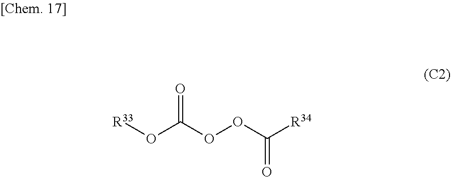

In the formula, R³³ and R³⁴ may be the same as or different from each other and each independently a group obtained by replacing at least one fluorine atom with a hydrogen atom in a C3-C10 perfluoroalkyl group optionally substituted with perfluorophenyl or a group obtained by replacing at least one fluorine atom with a hydrogen atom in perfluorophenyl optionally substituted with a linear or branched C1-C4 perfluoroalkyl group.

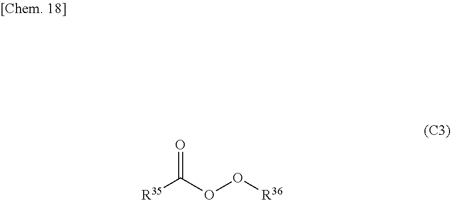

In the formula, R³⁵ and R³⁶ may be the same as or different from each other and each independently a group obtained by replacing at least one fluorine atom with a hydrogen atom in a C1-C10 perfluoroalkyl group optionally substituted with perfluorophenyl or a group obtained by replacing at least one fluorine atom with a hydrogen atom in perfluorophenyl optionally substituted with a linear or branched C1-C4 perfluoroalkyl group.

R³¹ and R³² may be the same as or different from each other and each independently a group obtained by replacing at least one fluorine atom with a hydrogen atom in perfluoropropyl, perfluoroisopropyl, perfluoro 2-phenyl-2-propyl, perfluorobutyl, perfluoro sec-butyl, perfluoro tert-butyl, perfluoropentyl, perfluoroisopentyl, perfluoroneopentyl, perfluoro 2-methyl-2-pentyl, perfluoro 2,4,4-trimethyl-2-pentyl, perfluorohexyl, perfluoro 2-methylhexyl, perfluoro 2-ethylhexyl, perfluorocyclohexyl, perfluoro 4-methylcyclohexyl, perfluoro 4-ethylcyclohexyl, perfluoro 4-tert-butylcyclohexyl, perfluoroheptyl, perfluoro 2-heptyl, perfluoro 3-heptyl, perfluorooctyl, perfluoro 2-methyl-2-octyl, perfluorononyl, perfluorodecyl, perfluorophenyl, perfluoro 2-methylphenyl, perfluoro 3-methylphenyl, or perfluoro 4-methylphenyl.

The number of fluorine atom(s) replaced with hydrogen atom(s) in R³¹ or R³² is one to the maximum number of replacement possible, preferably a number smaller by three than the maximum number of replacement possible to the maximum number of replacement possible, more preferably a number smaller by two than the maximum number of replacement possible to the maximum number of replacement possible, still more preferably a number smaller by one than the maximum number of replacement possible to the maximum number of replacement possible, particularly preferably the maximum number of replacement possible.

R³¹ and R³² may be the same as or different from each other and are more preferably each independently propyl, isopropyl, sec-butyl, 2-ethylhexyl, or 4-tert-butylcyclohexyl.

R³¹ and R³² may be the same as or different from each other and are particularly preferably each independently propyl or isopropyl.

Preferred examples of the compound (C1) include di-n-propyl peroxydicarbonate, diisopropyl peroxydicarbonate, di-sec-butyl peroxydicarbonate, bis(4-tertbutylcyclohexyl)peroxydicarbonate, di-2-ethylhexyl peroxydicarbonate, and di-2-ethylhexyl peroxydicarbonate.

The compound (C1) is particularly preferably di-n-propyl peroxydicarbonate or diisopropyl peroxydicarbonate.

R³³ and R³⁴ may be the same as or different from each other and each independently a group obtained by replacing at least one fluorine atom with a hydrogen atom in perfluoropropyl, perfluoroisopropyl, perfluoro 2-phenyl-2-propyl, perfluorobutyl, perfluoro sec-butyl, perfluoro tert-butyl, perfluoropentyl, perfluoro isopentyl, perfluoro neopentyl, perfluoro 2-methyl-2-pentyl, perfluoro 2,4,4-trimethyl-2-pentyl, perfluorohexyl, perfluoro 2-methylhexyl, perfluoro 2-ethylhexyl, perfluorocyclohexyl, perfluoro 4-methylcyclohexyl, perfluoro 4-methylcyclohexyl, perfluoro 4-ethylcyclohexyl, perfluoro 4-tert-butylcyclohexyl, perfluoroheptyl, perfluoro 2-heptyl, perfluoro 3-heptyl, perfluorooctyl, perfluoro 2-methyl-2-octyl, perfluorononyl, perfluorodecyl, perfluorophenyl, perfluoro 2-methylphenyl, perfluoro 3-methylphenyl, or perfluoro 4-methylphenyl.

The number of fluorine atom(s) replaced with hydrogen atom(s) in R³³ or R³⁴ is one to the maximum number of replacement possible, preferably a number smaller by three than the maximum number of replacement possible to the maximum number of replacement possible, more preferably a number smaller by two than the maximum number of replacement possible to the maximum number of replacement possible, still more preferably a number smaller by one than the maximum number of replacement possible to the maximum number of replacement possible.

R³³ and R³⁴ may be the same as or different from each other and are more preferably each independently isopropyl, 2,4,4-trimethylpentyl, ω-hydro-dodecafluorohexyl, ω-hydro-hexadecafluorooctyl, phenyl, or 3-methylphenyl.

Preferred examples of the compound (C2) include diisobutyryl peroxide, di(3,5,5-trimethylhexanoyl)peroxide, di(ω-hydro-dodecafluoroheptanoyl)peroxide, di(ω-hydro-hexadecafluorononanoyl)peroxide, ω-hydro-dodecafluoroheptanoyl-ω-hydrohexadecafluorononanoyl-peroxide, benzoyl peroxide, benzoyl m-methylbenzoyl peroxide, and m-toluoyl peroxide.

The compound (C2) is particularly preferably diisobutyryl peroxide, di(ω-hydro-dodecafluoroheptanoyl)peroxide, di(ω-hydro-hexadecafluoro nonanoyl)peroxide, ω-hydro-dodecafluoroheptanoyl-ω-hydrohexadecafluorononanoyl-peroxide, or benzoyl peroxide.

R³⁵ and R³⁶ may be the same as or different from each other and each independently a group obtained by replacing at least one fluorine atom with a hydrogen atom in perfluoromethyl, perfluroethyl, perfluoropropyl, perfluoroisopropyl, perfluoro 2-phenyl-2-propyl, perfluorobutyl, perfluoro sec-butyl, perfluoro tert-butyl, perfluoropentyl, perfluoroisopentyl, perfluoroneopentyl, perfluoro 2-methyl-2-pentyl, perfluoro 2,4,4-trimethyl-2-pentyl, perfluorohexyl, perfluoro 2-methylhexyl, perfluoro 2-ethylhexyl, perfluorocyclohexyl, perfluoro 4-methylcyclohexyl, perfluoro 4-ethylcyclohexyl, perfluoro 4-tert-butylcyclohexyl, perfluoroheptyl, perfluoro 2-heptyl, perfluoro 3-heptyl, perfluorooctyl, perfluoro 2-methyl-2-octyl, perfluorononyl, perfluorodecyl, perfluorophenyl, perfluoro 2-methylphenyl, perfluoro 3-methylphenyl, or perfluoro 4-methylphenyl.

The number of fluorine atom(s) replaced with hydrogen atom(s) in R³⁵ or R³⁶ is one to the maximum number of replacement possible, preferably a number smaller by three than the maximum number of replacement possible to the maximum number of replacement possible, more preferably a number smaller by two than the maximum number of replacement possible to the maximum number of replacement possible, still more preferably a number smaller by one than the maximum number of replacement possible to the maximum number of replacement possible, particularly preferably the maximum number of replacement possible.

R³⁵ and R³⁶ may be the same as or different from each other and are more preferably each independently isopropyl, 2-phenyl-2-propyl, tert-butyl, 2-methyl-2-pentyl, 2,4,4-trimethyl-2-pentyl, 2-heptyl, 2-methyl-2-octyl, phenyl, or 3-methylphenyl.

Preferred examples of the compound (C3) include tert-butyl peroxyneodecanoate, tert-butyl peroxypivalate, tert-hexyl peroxypivalate, tert-butyl peroxy isopropyl carbonate, and tert-butyl peroxyacetate.

The compound (C3) is particularly preferably tert-butyl peroxypivalate or tert-hexyl peroxypivalate.

Preferred examples of the inorganic peroxide include ammonium salts, sodium salts, and potassium salts of persulfuric acid, perboric acid, perchloric acid, perphosphoric acid, percarbonate, or permanganate.

The inorganic peroxide is particularly preferably ammonium persulfate, sodium persulfate, or potassium persulfate.

These inorganic peroxides may each be used alone or may be used in combination. The inorganic peroxide may be used in combination with a reducing agent such as a sulfite reducing agents (e.g. sodium dithionite) or a sulfite reducing agent (e.g. sodium sulfite, ammonium sulfite, or sodium hydrogen sulfite).

Preferred examples of the polymerization initiator include di-n-propyl peroxydicarbonate, diisopropyl peroxydicarbonate, diisobutyryl peroxide, di(ω-hydro-dodecafluoroheptanoyl)peroxide, di(ω-hydro-hexadecafluorononanoyl)peroxide, ω-hydro-dodecafluoroheptanoyl-ω-hydrohexadecafluorononanoyl-peroxide, benzoyl peroxide, tert-butyl peroxypivalate, tert-hexyl peroxypivalate, ammonium persulfate, sodium persulfate, and potassium persulfate.

The azo compound is preferably at least one selected from the group consisting of 2,2′-azobis(4-methoxy-2,4-dimethylvaleronitrile), and azobisisobutyronitrile, more preferably 2,2′-azobis(4-methoxy-2,4-dimethylvaleronitrile).

The polymerization initiator is particularly preferably di-n-propyl peroxydicarbonate, diisopropyl peroxydicarbonate, diisobutyryl peroxide, di(ω-hydro-dodecafluoroheptanoyl) peroxide, benzoyl peroxide, tert-butyl peroxypivalate, tert-hexyl peroxypivalate, or ammonium persulfate.

The step B is a step of polymerizing the fluorinated monomer to provide a phase-separated fine particulate containing a fluorine-containing resin. It is sufficient that the step B includes polymerization of the fluorinated monomer. A fluorinated monomer alone may be polymerized, or a fluorinated monomer and the above-described monomer copolymerizable with the fluorinated monomer may be polymerized.

The polymerization in the step B may be performed in conformity with a conventionally known polymerization method such as micro-emulsion polymerization, mini-emulsion polymerization, or micro-suspension polymerization.

Polymerization in the step B may also be suspension polymerization. Suspension polymerization of the dispersion of the solution can be performed by heating the dispersion under stirring.

The polymerization temperature may be any temperature enough to initiate polymerization of the fluorinated monomer (and an optional monomer copolymerizable with the fluorinated monomer) by an initiator, and is commonly 10° C. to 90° C., particularly preferably 30° C. to 80° C.

The polymerization is performed until a desired hollow fine particulate is obtained. The polymerization time varies in accordance with factors such as the types of the fluorine-containing monomer (and an optional monomer copolymerizable with the fluorine-containing monomer), the polymerization initiator, and the non-polymerizable solvent used, and is commonly about 3 to 24 hours.

The polymerization is preferably performed in an atmosphere of inert gas such as nitrogen gas or argon.

Polymerization performed as described above enables polymerization of the fluorinated monomer (or the fluorinated monomer and a monomer copolymerizable with the fluorine-containing monomer) in droplets of the solution.

The presence of the non-polymerizable solvent promotes phase separation of the resulting polymer (phase-separated fine particulate), which results in formation of a monolayer structured shell and a core including the non-polymerizable solvent therein. The shell in the phase-separated fine particulate includes a fluorine-containing resin containing a polymerized unit based on the fluorinated monomer (or a polymerized unit based on the fluorinated monomer and a polymerized unit based on a monomer copolymerizable with the fluorinated monomer).

The fluorine-containing resin has a glass transition temperature of preferably 60° C. or higher, more preferably 120° C. or higher because such a fluorine-containing resin can have a high strength and a high hardness.

In the disclosure, the glass transition temperature (Tg) can be determined using a differential scanning calorimeter (DSC) (DSC7000 available from Hitachi High-Tech Corp.) by increasing the temperature (first run), decreasing the temperature, and increasing the temperature (second run) within a temperature range from 30° C. to 200° C. at 10° C./min to obtain an endothermic curve, and determining the intermediate point of the endothermic curve as the glass transition temperature.

The fluorine-containing resin may consist only of a polymerized unit based on the fluorinated monomer or may contain a polymerized unit based on the fluorinated monomer and a polymerized unit based on a monomer copolymerizable with the fluorinated monomer.

The fluorinated monomer and the monomer copolymerizable with the fluorinated monomer are as those described in the production method of the disclosure.

The fluorine-containing resin preferably contains the polymerized unit based on the fluorinated monomer in an amount of preferably 10% by mass or more, more preferably 20% by mass or more, still more preferably 30% by mass or more, while preferably 95% by mass or less, more preferably 90% by mass or less, still more preferably 70% by mass or less, of all polymerized units. The amount of the polymerized unit based on the fluorinated monomer within the above range allows the resulting hollow fine particulate to have excellent electric properties.

The fluorine-containing resin preferably contains a polymerized unit based on the fluorinated monomer and a polymerized unit based on the crosslinkable monomer. This strengthens the shell of the hollow fine particulate. The strengthened shell of the hollow fine particulate can have a small thickness and lead to a high porosity.

The fluorine-containing resin contains a polymerized unit based on a crosslinkable monomer in an amount of preferably 5% by mass or more, more preferably 10% by mass or more, still more preferably 30% by mass or more, while preferably 90% by mass or less, more preferably 80% by mass or less, still more preferably 70% by mass or less, of all polymerized units. The amount of a polymerized unit based on a crosslinkable monomer within the above range allows the resulting hollow fine particulate to have excellent strength and excellent electric properties.

The fluorine-containing resin contains a polymerized unit based on a fluorine-free monomer in an amount of preferably 0 to 70% by mass, more preferably 0 to 50% by mass, of all polymerized units.

The fluorine-containing resin contains a polymerized unit based on a fluorine-containing monomer other than the fluorinated monomer in an amount of preferably 0 to 70% by mass, more preferably 0 to 50% by mass, of all polymerized units.

The fluorine-containing resin preferably contains a particulate dispersion stabilizer. The amount of the particulate dispersion stabilizer in the fluorine-containing resin is preferably 0.01% by mass or more, more preferably 0.1% by mass or more, still more preferably 1% by mass or more. The amount is preferably 10% by mass or less, more preferably 5% by mass or less, still more preferably 3% by mass or less. The particulate dispersion stabilizer in an amount within the above range can increase the dispersion stability in water and provides excellent storage stability.

The particulate dispersion stabilizer is as described in the production method of the disclosure.

The fluorine-containing resin preferably has a fluorine content of 10% by mass or higher. A fluorine content of 10% by mass or higher can lead to better electric properties and better water resistance. The fluorine content is more preferably 20% by mass or higher, still more preferably 30% by weight or higher, particularly preferably 50% by weigh of higher. The hollow fine particulate containing such a fluorine-containing resin can be produced by the production method of the disclosure described above, in particular a production method in which the step A includes the step A-1 or the step A-2.

The fluorine-containing resin preferably has a ratio by mass of a polymerized unit based on the fluorinated monomer (C) to a polymerized unit based on the crosslinkable monomer (E) (C/E) of preferably 80/20 to 20/80, more preferably 70/30 to 30/70, still more preferably 60/40 to 40/60.

The fluorine-containing resin preferably has a relative permittivity (1 kHz) of 5.0 or lower. The relative permittivity is more preferably 4.0 or lower, still more preferably 3.7 or lower, particularly preferably 3.5 or lower. The lower limit of the relative permittivity may be, but is not limited to, 1.1 or higher, for example.

In the disclosure, the relative permittivity is a value determined by a measurement method in conformity with JIS C2138.

The fluorine-containing resin preferably has a refractive index of 1.40 or lower. The refractive index is more preferably 1.39 or lower, particularly preferably 1.38 or lower. The lower limit of the refractive index may be, but is not limited to, 1.30 or higher, and is preferably 1.35 or higher from the viewpoint of solubility in a non-polymerizable solvent.

The refractive index is a value determined by the immersion method.

The step C is a step of removing the non-polymerizable solvent in the phase-separated fine particulate to provide a hollow fine particulate. A hollow fine particulate containing substantially no non-polymerizable solvent can be obtained in the step C.

Non-limiting examples of the method of removing the non-polymerizable solvent include heat treatment, depressurization, and natural drying. In view of convenience and economy, heat treatment is preferred. The conditions of the heat treatment may be appropriately set depending on the type, amount, and the like of the non-polymerizable solvent. Preferably, the heat treatment is performed at a temperature of about 20° C. to 300° C. and a pressure of about 1 to 100000 Pa.

The production method of the disclosure including the step A to the step C enables production of a hollow fine particulate having a large particle size. The average particle size of the hollow fine particulate is preferably 1.0 μm or greater, more preferably 2.0 μm or greater, still more preferably 5.0 μm or greater. In view of particle stability, the average particle size is preferably 50.0 μm or less, more preferably 30.0 μm or less.

In the disclosure, the average particle size may be determined by dynamic light scattering (DLS). Alternatively, the average particle size may be calculated from an optical micrograph using particle size analyzing software LUZEX AP. In this case, preferably, multiple pictures are taken such that they include 50 or more particles in total for analysis.

The hollow fine particulate may have what is called a nesting structure, but preferably has a monoporous structure including a shell containing the fluorine-containing resin and a hollow portion.

In the disclosure, the “monoporous structure” does not encompass structures having multiple pores, such as a multiporous structure, but refers to structures having a single, closed pore. In the following description, the portion other than the pore of the hollow fine particulate is referred to as a “shell”.

The pore size of the hollow portion is preferably 66% or higher, more preferably 74% or higher, still more preferably 79% or higher. The percentage is preferably 95% or lower, more preferably 93% or lower, still more preferably 90% or lower, particularly preferably 88% or lower, of the diameter of the hollow fine particulate.

In the disclosure, pore size of the hollow portion may be determined by an image analysis of a TEM micrograph of the hollow fine particulate using particle size analyzing software LUZEX AP. Specifically, the pore size of the hollow portion can be calculated by randomly extracting about 200 hollow fine particles in the TEM micrograph, measuring the inner diameters (R1) of the particles, and calculating the pore size by the following formula:

$$Pore size of hollow portion = R 1 \times 2.$$

The percentage of the thickness of the shell relative to the diameter of the hollow fine particulate in the hollow fine particulate is preferably 17% or lower, more preferably 13% or lower, still more preferably 10% or lower, particularly preferably 9% or lower. A small shell thickness can lead to a high porosity, resulting in a hollow fine particulate having a lower permittivity.

From the viewpoint of strength of the hollow fine particulate, the percentage is preferably 4% or higher, more preferably 6% or higher.

In the disclosure, the thickness of the shell may be determined by an image analysis of an optical micrograph or a TEM micrograph of the hollow fine particulate using particle size analyzing software LUZEX AP. Specifically, the thickness of the shell can be calculated by randomly extracting about 50 to 200 hollow fine particles in the optical micrograph or the TEM micrograph, measuring the inner diameters (R1) and the outer diameters (R2) of the particles, and calculating the thickness of the shell by the following formula:

$$Thickness of shell = R 2 - R 1.$$

The porosity of the hollow fine particulate is preferably 30% by volume or higher, more preferably 40% by volume or higher, still more preferably 50% by volume or higher, particularly preferably 55% by volume or higher. A hollow fine particulate having a high porosity can have a low relative permittivity and is suitable for the use as an electronic material. From the viewpoint of strength of the hollow fine particulate, the upper limit of the porosity is preferably, but is not limited to, 80% by volume or lower, more preferably 70% by volume or lower.

In the disclosure, the porosity is calculated by the following formula:

$$Porosity M ( \% by volume ) = amount of non - polymerizable solvent \text{} ( g ) / ( amount of fluorinated monomer ( g ) + amount of crosslinkable monomer ( g ) + amount of non - polymerizable solvent ( g ) ) \times 100.$$

The refractive index of the hollow fine particulate is preferably 1.40 or lower, more preferably 1.35 or lower, still more preferably 1.30 or lower, particularly preferably 1.25 or lower. The lower limit of the refractive index is not limited and may be 1.10 or higher, for example.

The refractive index is a value determined by the immersion method.

When a phase separation promoter is used, the phase separation promoter is included in the shell of the hollow fine particulate. From the viewpoints of electric properties, the amount of the phase separation promoter in the hollow fine particulate is preferably small. Thus, in the production method of the disclosure, the amount of the phase separation promoter used is preferably as small as possible.

The amount of the phase separation promoter in the hollow fine particulate relative to the fluorine-containing resin is preferably 5% by mass or less, more preferably 1% by mass or less, preferably 0.1% by mass or less. The lower limit is not limited and may be 0% by mass.

From the viewpoints of low dielectricity and low refractive index, the hollow portion of the hollow fine particulate is preferably a gas, more preferably the air.

### (Hollow Fine Particulate)

The hollow fine particulate of the disclosure can be obtained by the production method of the disclosure. The suitable embodiments of the production method of the disclosure described above are also applicable to the hollow fine particulate of the disclosure.

The hollow fine particulate of the disclosure contains a fluorine-containing resin containing a polymerized unit based on a fluorinated monomer, contains substantially no non-polymerizable solvent, and has an average particle size of 1.0 μm or greater.

The hollow fine particulate of the disclosure may have what is called a nesting structure, but preferably has a monoporous structure including a shell containing the fluorine-containing resin and a hollow portion.

The “monoporous structure” in the disclosure does not encompass structures having multiple pores, such as a multiporous structure, but refers to structures having a single, closed pore. In the following description, the portion other than the pore of the hollow fine particulate is referred to as a “shell”.

The particle size of the hollow fine particulate of the disclosure can be adjusted by changing the sizes of the droplets in the production method of the disclosure. Conventional methods have difficulty in providing an increased average particle size for a hollow fine particulate containing a fluorine-containing resin.

The production method of the disclosure described above allows a hollow fine particulate containing a fluorine-containing resin to have an increased average particle size, and thus can produce a hollow fine particulate having an average particle size of 1.0 μm or greater.

The hollow fine particulate of the disclosure contains substantially no non-polymerizable solvent. The expression “the hollow fine particulate contains substantially no non-polymerizable solvent” means that a non-polymerizable solvent content of the hollow fine particulate is 0.1% by mass or lower. The hollow fine particulate of the disclosure may be completely free of non-polymerizable solvent.

The hollow fine particulate of the disclosure has an average particle size of 1.0 μm or greater. The average particle size is preferably 2.0 μm or greater, more preferably 5.0 μm or greater. The average particle size is preferably 50.0 μm or less, more preferably 40.0 μm or less, still more preferably 30.0 μm or less.

The hollow fine particulate of the disclosure is hollow and thus has excellently low dielectricity and excellent high-frequency characteristics. Thus, the hollow fine particulate is suitable for use as an electronic material. In other words, the hollow fine particulate of the disclosure is preferably for use as an electronic material.

The hollow fine particulate of the disclosure contains the fluorine-containing resin and has an average particle size of 1.0 μm or greater. Thus, the hollow fine particulate can have a low permittivity and have a smaller surface area than others when they are used at the same volume. Thus, the hollow fine particulate is suitable as an electronic material. A smaller average particle size leads to a larger specific surface area, which may significantly reduce the electric properties due to moisture attached to the interface, for example.

### (Phase-Separated Fine Particulate)

An aqueous dispersion containing the phase-separated fine particulate of the disclosure (aqueous dispersion of the disclosure) can be obtained by performing the step A and the step B in the production method of the disclosure. The phase-separated fine particulate of the disclosure may be used directly as an aqueous dispersion or may be filtered, optionally washed with water, and then used in the form of powder. The suitable embodiments of the production method of the disclosure described above are also applicable to the phase-separated fine particulate of the disclosure.

The phase-separated fine particulate of the disclosure contains a fluorine-containing resin containing a polymerized unit based on the fluorinated monomer and a non-polymerizable solvent and has an average particle size of 1.0 μm or greater.

The phase-separated fine particulate of the disclosure is different from the hollow fine particulate of the disclosure in that the hollow portion includes a non-polymerizable solvent. The amount of the non-polymerizable solvent relative to the phase-separated fine particulate is preferably 10% by mass or more, more preferably 30% by mass or more. The non-polymerizable solvent content relative to the phase-separated fine particulate content is preferably 70% by mass or less, more preferably 60% by mass or less.

The phase-separated fine particulate of the disclosure has an average particle size of 1.0 μm or greater. The average particle size is preferably 2.0 μm or greater, more preferably 5.0 μm or greater. The average particle size is preferably 50.0 μm or less, more preferably 40.0 μm or less, still more preferably 30.0 μm or less.

Like the hollow fine particulate of the disclosure, the phase-separated fine particulate of the disclosure is suitable for use in an electronic material. In other words, the phase-separated fine particulate of the disclosure is preferably used for an electronic material.

### (Composition)

The first composition of the disclosure contains the hollow fine particulate of the disclosure and a fluorine-containing resin containing a polymerized unit based on the fluorinated monomer.

The first composition of the disclosure may be a composition which is intentionally produced by mixing the hollow fine particulate and the fluorine-containing resin or a composition generated during the production of the hollow fine particulate.

In the formation of the first composition of the disclosure, the fluorine-containing resin is separately added from the fluorine-containing resin in the hollow fine particulate. The fluorine-containing resin described in the production method of the disclosure may be usable as the fluorine-containing resin.

In the first composition of the disclosure, the composition ratio of the fluorine-containing resin to the hollow fine particulate is not limited. For example, the composition ratio by mass (fluorine-containing resin/hollow fine particulate) in the composition is any ratio between 5/95 to 95/5.

The first composition of the disclosure is preferable in that the electric properties are controllable while maintaining a high fluorine content.

The second composition of the disclosure contains the phase-separated fine particulate of the disclosure and a fluorine-containing resin containing a polymerized unit based on the fluorinated monomer.

The second composition of the disclosure may be a composition which is intentionally produced by mixing the phase-separated fine particulate and the fluorine-containing resin or a composition generated during the production of the phase-separated fine particulate.

In the formation of the second composition of the disclosure, the fluorine-containing resin is separately added from the fluorine-containing resin in the phase-separated fine particulate. The fluorine-containing resin described in the production method of the disclosure may be usable as the fluorine-containing resin.

In the second composition of the disclosure, the composition ratio of the fluorine-containing resin to the phase-separated fine particulate is not limited. For example, the composition ratio by mass (fluorine-containing resin/phase-separated fine particulate) in the composition is any ratio between 5/95 to 95/5.

Like the first composition of the disclosure, the second composition of the disclosure is preferable in that the electric properties are controllable while maintaining a high fluorine content.

The disclosure relates to a method for producing a hollow fine particulate including:
a step A of dispersing a solution containing a fluorinated monomer and a non-polymerizable solvent into water to provide a dispersion;
a step B of polymerizing the fluorinated monomer to provide a phase-separated fine particulate containing a fluorine-containing resin; and
a step C of removing the non-polymerizable solvent in the phase-separated fine particulate to provide a hollow fine particulate.

Preferably, in the step A, the dispersion contains a particulate dispersion stabilizer.

Preferably, in the step A, the particulate dispersion stabilizer is a fluorine-containing particulate dispersion stabilizer.

The fluorinated monomer is preferably a high-fluorine-conversion monomer having a fluorine conversion FC of 70% or higher, the fluorine conversion FC being calculated by the following formula:

$$Fluorine conversion FC ( \% ) = ( the number of C - F bonds in a monomer molecule ) \text{} / \{ ( the number of C - F bonds in a monomer molecule ) + ( the number of C - H bonds in a monomer molecule ) \} \times 100.$$

The high-fluorine-conversion monomer preferably has a fluorine conversion FC of 80% or higher.

The high-fluorine-conversion monomer preferably has a fluorine conversion FC of 100%.

The high-fluorine-conversion monomer is preferably a high-fluorine-conversion olefin.

The high-fluorine-conversion olefin is preferably a high-fluorine-conversion cyclic olefin or a monomer represented by the following formula (b), (d), or (e):

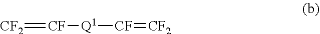

wherein Q¹ is a C1-C5 linear or optionally branched perfluoroalkylene group optionally containing an ether bond;

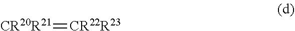

wherein R²⁰ to R²³ are each independently a fluorine atom, a C1-C5 perfluoroalkyl group, or a C1-C5 perfluoroalkoxy group; or

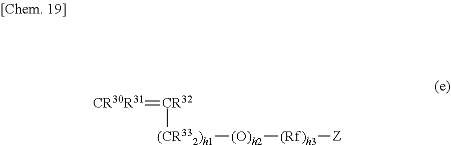

wherein R³⁰ and R³¹ are each independently H or F; R³² is H, F, or CF₃; R³³ is H, F, or CF₃; h1 to h3 are each independently 0 or 1; Z is H, F, Cl, —OH, CH₂OH, —COOH, —COF, a carboxylic acid derivative, —SO₃H, a sulfonic acid derivative, an epoxy group, or a cyano group; and Rf is a C1-C20 linear or branched fluorine-containing alkylene group or a C2-C100 linear or branched fluorine-containing alkylene group containing an ether bond.

The high-fluorine-conversion cyclic olefin is preferably a monomer represented by the following formula (a) or (c):

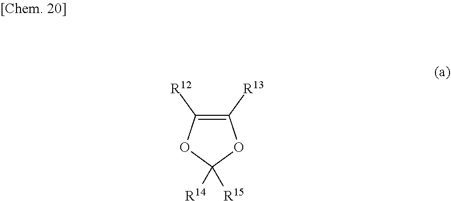

wherein R¹² to R¹⁵ are each independently a fluorine atom, a C1-C5 perfluoroalkyl group, or a C1-C5 perfluoroalkoxy group; or

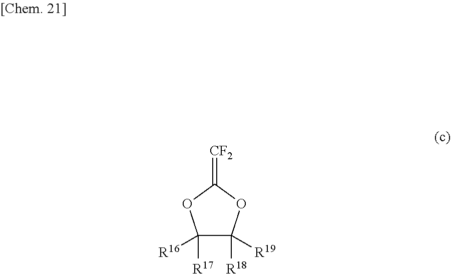

wherein R¹⁶ to R¹⁹ are each independently a fluorine atom, a C1-C5 perfluoroalkyl group, or a C1-C5 perfluoroalkoxy group.

The high-fluorine-conversion olefin is preferably a monomer represented by the formula (c).

The solution preferably further contains a crosslinkable monomer.

The crosslinkable monomer is preferably a multifunctional monomer containing two or more polymerizable reactive groups.

The crosslinkable monomer is preferably a high-fluorine-conversion multifunctional monomer containing two or more polymerizable reactive groups and having a fluorine conversion FC of 50% or higher, the fluorine conversion FC being calculated by the following formula:

$$Fluorine conversion FC ( \% ) = ( the number of C - F bonds in a monomer molecule ) \text{} / \{ ( the number of C - F bonds in a monomer molecule ) + ( the number of C - H bonds in a monomer molecule ) \} \times 100.$$

Preferably, the high-fluorine-conversion multifunctional monomer is:
CF₂═CF—O—(CF₂)ₙ—O—CF═CF₂, wherein n=1 to 20;
CF₂═CF—(CF₂)ₙ—O—CF═CF₂, wherein n=1 to 20; or
CF₂═CF—(CF₂)ₘ—CF═CF₂, wherein m=1 to 20.

Preferably, in the step B, the fluorine-containing resin has a glass transition temperature of 60° C. or higher.

Preferably, in the step B, the glass transition temperature of the fluorine-containing resin is 120° C. or higher.

The non-polymerizable solvent is preferably a fluorine-containing non-polymerizable solvent.

The fluorine-containing non-polymerizable solvent preferably includes at least one selected from the group consisting of a perfluoro aromatic compound, a perfluorotrialkylamine, a perfluoroalkane, a hydrofluorocarbon, a perfluoro cyclic ether, a fluorine-containing alcohol, and a hydrofluoroether.

The fluorine-containing non-polymerizable solvent preferably includes at least one selected from the group consisting of a C3-C8 hydrofluorocarbon, a C1-C5 fluorine-containing alcohol, and a C3-C8 hydrofluoroether.

The hollow fine particulate preferably has an average particle size of 1.0 μm or greater.

The hollow fine particulate preferably has a porosity of 30% by volume or higher.

The porosity of the hollow fine particulate is preferably 40% by volume or higher.

The disclosure also relates to a hollow fine particulate including:
a fluorine-containing resin containing a polymerized unit based on a fluorinated monomer,
the hollow fine particulate containing substantially no non-polymerizable solvent,
the hollow fine particulate having an average particle size of 1.0 μm or greater.

The fluorinated monomer is preferably a high-fluorine-conversion monomer having a fluorine conversion FC of 70% or higher, the fluorine conversion FC being calculated by the following formula:

$$Fluorine conversion FC ( \% ) = ( the number of C - F bonds in a monomer molecule ) \text{} / \{ ( the number of C - F bonds in a monomer molecule ) + ( the number of C - H bonds in a monomer molecule ) \} \times 100.$$

The high-fluorine-conversion monomer preferably has a fluorine conversion FC of 80% or higher.

The high-fluorine-conversion monomer preferably has a fluorine conversion FC of 100%.

The high-fluorine-conversion monomer is preferably a high-fluorine-conversion olefin.

The high-fluorine-conversion olefin is preferably a high-fluorine-conversion cyclic olefin or a monomer represented by the following formula (b), (d), or (e):

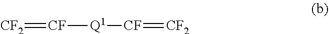

wherein Q¹ is a C1-C5 linear or optionally branched perfluoroalkylene group optionally containing an ether bond;

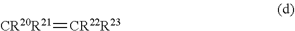

wherein R²⁰ to R²³ are each independently a fluorine atom, a C1-C5 perfluoroalkyl group, or a C1-C5 perfluoroalkoxy group; or

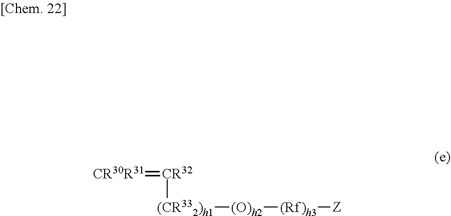

wherein R³⁰ and R³¹ are each independently H or F; R³² is H, F, or CF₃; R³³ is H, F, or CF₃; h1 to h3 are each independently 0 or 1; Z is H, F, Cl, —OH, CH₂OH, —COOH, —COF, a carboxylic acid derivative, —SO₃H, a sulfonic acid derivative, an epoxy group, or a cyano group; and Rf is a C1-C20 linear or branched fluorine-containing alkylene group or a C2-C100 linear or branched fluorine-containing alkylene group containing an ether bond.

The high-fluorine-conversion cyclic olefin is preferably a monomer represented by the following formula (a) or (c):

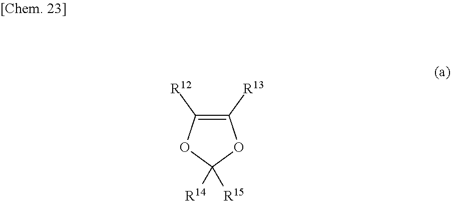

wherein R¹² to R¹⁵ are each independently a fluorine atom, a C1-C5 perfluoroalkyl group, or a C1-C5 perfluoroalkoxy group; or

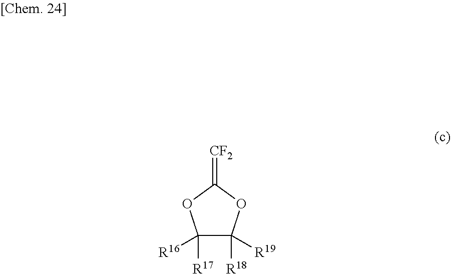

wherein R¹ to R¹⁹ are each independently a fluorine atom, a C1-C5 perfluoroalkyl group, or a C1-C5 perfluoroalkoxy group.

The high-fluorine-conversion olefin is preferably a monomer represented by the formula (c).

The fluorine-containing resin preferably further contains a polymerized unit based on a crosslinkable monomer.

The crosslinkable monomer is preferably a multifunctional monomer containing two or more polymerizable reactive groups.

The crosslinkable monomer is preferably a high-fluorine-conversion multifunctional monomer containing two or more polymerizable reactive groups and having a fluorine conversion FC of 50% or higher, the fluorine conversion FC being calculated by the following formula:

$$Fluorine conversion FC ( \% ) = ( the number of C - F bonds in a monomer molecule ) \text{} / \{ ( the number of C - F bonds in a monomer molecule ) + ( the number of C - H bonds in a monomer molecule ) \} \times 100.$$

Preferably, the high-fluorine-conversion multifunctional monomer is:
CF₂═CF—O—(CF₂)ₙ—O—CF═CF₂, wherein n=1 to 20;
CF₂═CF—(CF₂)ₙ—O—CF═CF₂, wherein n=1 to 20; or
CF₂═CF—(CF₂)ₘ—CF═CF₂, wherein m=1 to 20.

The fluorine-containing resin preferably has a glass transition temperature of 60° C. or higher.

The glass transition temperature of the fluorine-containing resin is preferably 120° C. or higher.

The hollow fine particulate preferably has a porosity of 30% by volume or higher.

The porosity of the hollow fine particulate is preferably 40% by volume or higher.

The fluorine-containing resin preferably contains a particulate dispersion stabilizer.

The particulate dispersion stabilizer is preferably a fluorine-containing particulate dispersion stabilizer.

The hollow fine particulate is preferably used for an electronic material.

The disclosure also relates to a phase-separated fine particulate including:
a fluorine-containing resin containing a polymerized unit based on a fluorinated monomer; and
a non-polymerizable solvent,
the phase-separated fine particulate having an average particle size of 1.0 μm or greater.

The fluorinated monomer is preferably a high-fluorine-conversion monomer having a fluorine conversion FC of 70% or higher, the fluorine conversion FC being calculated by the following formula:

$$Fluorine conversion FC ( \% ) = ( the number of C - F bonds in a monomer molecule ) \text{} / \{ ( the number of C - F bonds in a monomer molecule ) + ( the number of C - H bonds in a monomer molecule ) \} \times 100.$$

The high-fluorine-conversion monomer preferably has a fluorine conversion FC of 80% or higher.

The high-fluorine-conversion monomer preferably has a fluorine conversion FC of 100%.

The high-fluorine-conversion monomer is preferably a high-fluorine-conversion olefin.

The high-fluorine-conversion olefin is preferably a high-fluorine-conversion cyclic olefin or a monomer represented by the following formula (b), (d), or (e):

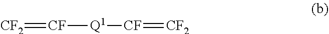

wherein Q¹ is a C1-C5 linear or optionally branched perfluoroalkylene group optionally containing an ether bond;

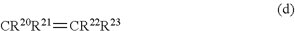

wherein R²⁰ to R²³ are each independently a fluorine atom, a C1-C5 perfluoroalkyl group, or a C1-C5 perfluoroalkoxy group; or

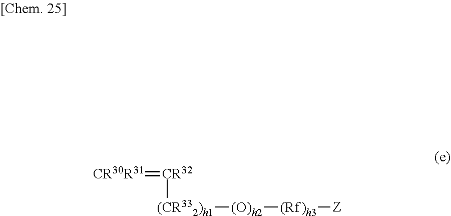

wherein R³⁰ and R³¹ are each independently H or F; R³² is H, F, or CF₃; R³³ is H, F, or CF₃; h1 to h3 are each independently 0 or 1; Z is H, F, Cl, —OH, CH₂OH, —COOH, —COF, a carboxylic acid derivative, —SO₃H, a sulfonic acid derivative, an epoxy group, or a cyano group; and Rf is a C1-C20 linear or branched fluorine-containing alkylene group or a C2-C100 linear or branched fluorine-containing alkylene group containing an ether bond.

The high-fluorine-conversion cyclic olefin is preferably a monomer represented by the following formula (a) or (c):

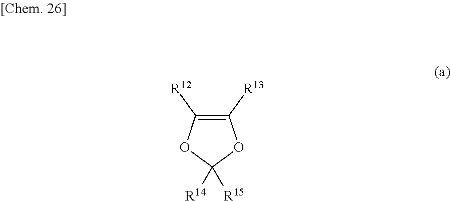

wherein R¹² to R¹⁵ are each independently a fluorine atom, a C1-C5 perfluoroalkyl group, or a C1-C5 perfluoroalkoxy group; or

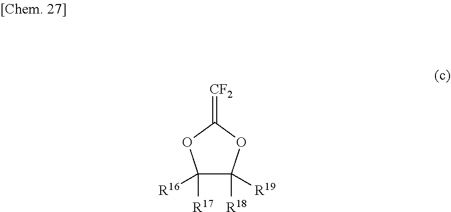

wherein R¹⁶ to R¹⁹ are each independently a fluorine atom, a C1-C5 perfluoroalkyl group, or a C1-C5 perfluoroalkoxy group.

The high-fluorine-conversion olefin is preferably a monomer represented by the formula (c).

The fluorine-containing resin further preferably contains a polymerized unit based on a crosslinkable monomer.

The crosslinkable monomer is preferably a multifunctional monomer containing two or more polymerizable reactive groups.

The crosslinkable monomer is preferably a high-fluorine-conversion multifunctional monomer containing two or more polymerizable reactive groups and having a fluorine conversion FC of 50% or higher, the fluorine conversion FC being calculated by the following formula:

$$Fluorine conversion FC ( \% ) = ( the number of C - F bonds in a monomer molecule ) \text{} / \{ ( the number of C - F bonds in a monomer molecule ) + ( the number of C - H bonds in a monomer molecule ) \} \times 100.$$

Preferably, the high-fluorine-conversion multifunctional monomer is:
CF₂═CF—O—(CF₂)ₙ—O—CF═CF₂, wherein n=1 to 20;
CF₂═CF—(CF₂)ₙ—O—CF═CF₂, wherein n=1 to 20; or
CF₂═CF—(CF₂)ₘ—CF═CF₂, wherein m=1 to 20.

The fluorine-containing resin preferably has a glass transition temperature of 60° C. or higher.

The glass transition temperature of the fluorine-containing resin is preferably 120° C. or higher.

The hollow fine particulate preferably has a porosity of 30% by volume or higher.

The porosity of the hollow fine particulate is preferably 40% by volume or higher.

The fluorine-containing resin preferably contains a particulate dispersion stabilizer.

The particulate dispersion stabilizer is preferably a fluorine-containing particulate dispersion stabilizer.

The disclosure also relates to an aqueous dispersion including the phase-separated fine particulate.

The disclosure also relates to a composition containing:
the hollow fine particulate; and
a fluorine-containing resin containing a polymerized unit based on a fluorinated monomer.

The disclosure also relates to a composition containing:
the phase-separated fine particulate; and
a fluorine-containing resin containing a polymerized unit based on a fluorinated monomer.

### EXAMPLES

The disclosure is described in more detail below with reference to examples, but is not limited to these examples.

The numerical values in the examples were measured by the following methods.

### (Average Particle Size)

The particle size was calculated by image analysis of an optical micrograph of the fine particles using particle size analyzing software LUZEX AP. Specifically, pictures of different positions were taken such that they included 50 or more particles in total. Then, the average particle size was calculated.

### (Porosity)

The porosity was calculated by the following formula:

$$Porosity M ( \% by volume ) = amount of non - polymerizable solvent \text{} ( g ) / ( amount of fluorinated monomer ( g ) + amount of crosslinkable monomer ( g ) + amount of non - polymerizable solvent ( g ) ) \times 100.$$

The porosity M of the phase-separated fine particulate is equal to that of the hollow fine particulate.

### (Glass Transition Temperature)

A differential scanning calorimeter (DSC) (DSC7000 available from Hitachi High-Tech Corp.) was used to increase the temperature (first run), decrease the temperature, and increase the temperature (second run) within a temperature range from 30° C. to 200° C. at 10° C./min so that an endothermic curve was obtained, and the intermediate point of the endothermic curve was determined as the glass transition temperature (° C.).

### (Fluorine Conversion FC (%))

$$Fluorine conversion FC ( \% ) = ( the number of C - F bonds in a monomer molecule ) \text{} / \{ ( the number of C - F bonds in a monomer molecule ) + ( the number of C - H bonds in a monomer molecule ) \} \times 100.$$

### (Degree of Polymerization)

After polymerization, drying was performed at a temperature of 100° C. for 24 hours. The solid concentration ratio Z was calculated from the residue. The degree of polymerization C (%) was calculated from the ratio of charged monomers (ratio Q of a total amount of the fluorinated monomer and the crosslinkable monomer relative to the total weight) using the following formula:

$$Degree of polymerization C ( \% ) = Z / Q \times 100 ( \% ) .$$

### Example 1

Perfluoro(2-methylene-4-methyl-1,3-dioxolane) (monomer a7, a monomer represented by the formula (a-7)) was used as a fluorine-containing monomer; 1,1,2,2,3,3-hexafluoro-1,3-bis[(1,2,2-trifluorovinyl)oxy]propane (PFDVE) (CF₂═CF—O—(CF₂)₃—O—CF═CF₂) was used as a crosslinkable monomer; a solution of 1,1,2,2,3,3,4-heptafluorocyclopentane (HFCP), which is a hydrofluorocarbon, was used as a non-polymerizable solvent; lauroyl peroxide was used as a polymerization initiator; and polyvinyl alcohol (PVA) with a Pn of 1700 and a degree of saponification of 88% was used as a particulate dispersion stabilizer.

The monomer a7 as a fluorine-containing monomer had a fluorine conversion FC of 100%, and the PEDVE as a crosslinkable monomer also had a fluorine conversion FC of 100%.

According to the composition shown in the following Table 1, the PFDVE as a crosslinkable monomer and the monomer a7 as a fluorine-containing monomer in a mass ratio of 3:2 were added to the HFCP solution. Further, lauroyl peroxide as a polymerization initiator was dissolved to prepare a homogenous oil phase, and the oil phase was dispersed in an aqueous medium in which PVA was dissolved to a predetermined concentration in advance using a homogenizer to prepare suspension droplets. The suspension droplets were stirred in a nitrogen atmosphere at 60° C. and 180 rpm for 24 hours to perform polymerization. Thus, suspended particles dispersed in water were produced.

TABLE 1

| | | Amount (g) |
|---|---|---|
| Fluorinated monomer | Monomer a7 | 0.36 |
| Crosslinkable monomer | PFDVE | 0.24 |
| Non-polymerizable solvent | HFCP | 0.6 |
| Particulate dispersion stabilizer | PVA | 0.02 |
| Polymerization initiator | Lauroyl peroxide | 0.012 |
| Dispersion medium | Water | 5 |

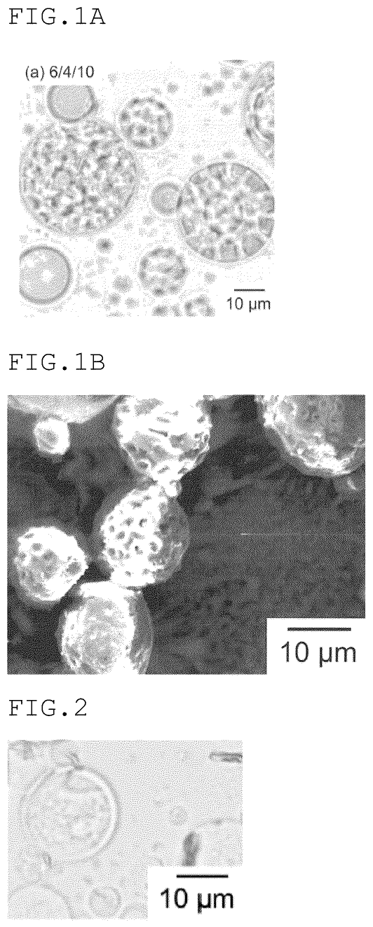

FIG. 1A shows an optical micrograph of suspended particles dispersed in water after polymerization. The optical micrograph after polymerization indicates that particles with a hollow structure (pores) were obtained.

The obtained suspended particles dispersed in water were a phase-separated fine particulate including the non-polymerizable solvent in its inside.

The average particle size calculated from the optical micrograph was 19 μm.

The phase-separated fine particulate had a porosity M of 50% by volume.

### Example 2

The phase-separated fine particulate obtained in Example 1 was subjected to isolation and drying at 60° C. for 24 hours and then observed by SEM. FIG. 1B shows the result. A hollow fine particulate with a well-defined porous structure was obtained.

As understood also from the optical micrograph in Example 1 (FIG. 1A), no distinct shell was formed, and the surface observed by SEM had a porous structure.

### Example 3

The glass transition temperature of the fluorine-containing resin in the hollow fine particulate obtained in Example 2 was measured and found to be 138° C.

### Example 4

Suspended particles dispersed in water were produced by performing polymerization as in Example 1, except that the percentages of the monomers were changed (using no crosslinkable monomer) and the rotation speed during the stirring was changed to 200 rpm. Table 2 shows the composition.

TABLE 2

| | | Amount (g) |
|---|---|---|
| Fluorinated monomer | Monomer a7 | 0.6 |
| Non-polymerizable solvent | HFCP | 0.6 |
| Particulate dispersion stabilizer | PVA | 0.02 |
| Polymerization initiator | Lauroyl peroxide | 0.012 |
| Dispersion medium | Water | 5 |

FIG. 2 shows an optical micrograph of suspended particles dispersed in water after polymerization. The optical micrograph after polymerization indicates that particles with a hollow structure (pores) were obtained.

The obtained suspended particles dispersed in water were a phase-separated fine particulate including the non-polymerizable solvent in its inside.

The average particle size calculated from the optical micrograph was 11 μm.

The phase-separated fine particulate had a porosity M of 50% by volume.

### Example 5

The phase-separated fine particulate obtained in Example 4 was subjected to isolation and drying at 60° C. for 24 hours to obtain a hollow fine particulate with a spherical structure.

As understood from the optical micrograph in Example 4 (FIG. 2), distinct shells were formed, and the surfaces observed by SEM had shell-based spherical structures.

Meanwhile, cave-in was partly observed, suggesting an internal porous structure.

### Example 6

The glass transition temperature of the fluorine-containing resin in the hollow fine particulate obtained in Example 5 was measured and found to be 130° C.

### Example 7

Suspended particles dispersed in water were produced by performing polymerization as in Example 1, except that the percentages of the monomers were changed and the rotation speed during the stirring was changed to 200 rpm. Table 3 shows the composition.

TABLE 3

| | | Amount (g) |
|---|---|---|
| Fluorinated monomer | Monomer a7 | 0.24 |
| Crosslinkable monomer | PFDVE | 0.36 |
| Non-polymerizable solvent | HFCP | 0.6 |
| Particulate dispersion stabilizer | PVA | 0.02 |
| Polymerization initiator | Lauroyl peroxide | 0.012 |
| Dispersion medium | Water | 5 |

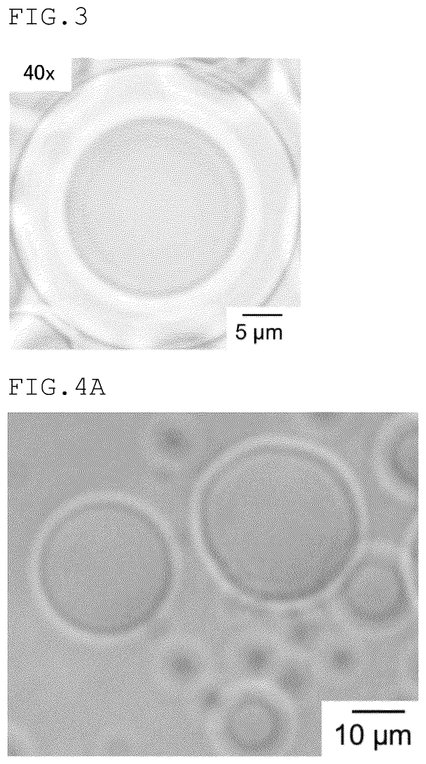

FIG. 3 shows an optical micrograph of suspended particles dispersed in water after polymerization. The optical micrograph after polymerization indicates that particles with a hollow structure (single pore) were obtained.

The obtained suspended particles dispersed in water were a phase-separated fine particulate including the non-polymerizable solvent in its inside.

The average particle size calculated from the optical micrograph was 16 μm.

The phase-separated fine particulate had a porosity M of 50% by volume.

As in Example 5, the phase-separated fine particulate obtained in Example 7 was subjected to isolation and drying at 60° C. for 24 hours to obtain a hollow fine particulate (not shown).

### Example 8

Suspended particles dispersed in water were produced by performing polymerization as in Example 7, except that the polymerization initiator was changed to benzoyl peroxide (BPO) and the polymerization temperature was changed to 70° C. Table 4 shows the composition.

TABLE 4

| | | Amount (g) |
|---|---|---|
| Fluorinated monomer | Monomer a7 | 0.24 |
| Crosslinkable monomer | PFDVE | 0.36 |
| Non-polymerizable solvent | HFCP | 0.6 |
| Particulate dispersion stabilizer | PVA | 0.02 |
| Polymerization initiator | BPO | 0.012 |
| Dispersion medium | Water | 5 |

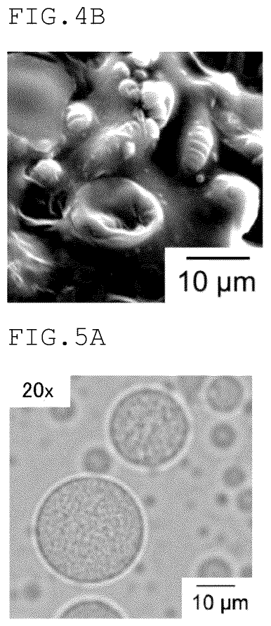

FIG. 4A shows an optical micrograph of suspended particles dispersed in water after polymerization. The optical micrograph after polymerization indicates that particles with a hollow structure (single pore) were obtained.

The obtained suspended particles dispersed in water were a phase-separated fine particulate including the non-polymerizable solvent in its inside.

The average particle size calculated from the optical micrograph was 17 μm.

The phase-separated fine particulate had a porosity M of 50% by volume.

### Example 9

The phase-separated fine particulate obtained in Example 8 was subjected to isolation and drying at 70° C. for 24 hours and then observed by SEM. FIG. 4B shows the result. Some particles with a large particle size of the hollow fine particulate had a collapsed hollow structure.

### Example 10

Suspended particles dispersed in water were produced as in Example 8, except that the polymerization temperature was changed to 80° C.

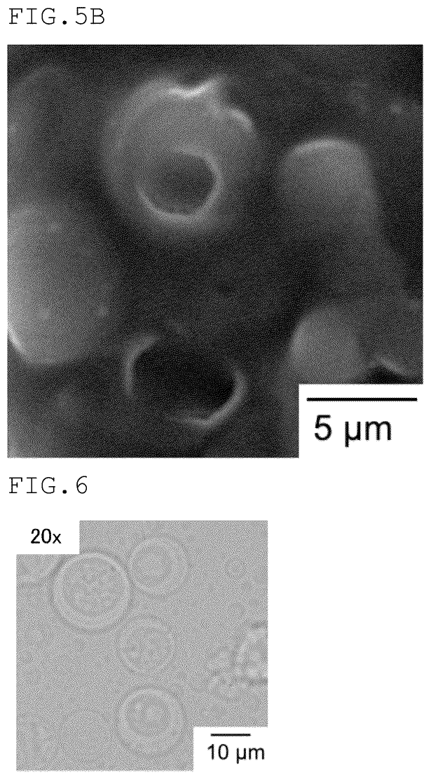

FIG. 5A shows an optical micrograph of suspended particles dispersed in water after polymerization. The optical micrograph after polymerization indicates that particles with a hollow structure (pores) were obtained.

The obtained suspended particles dispersed in water were a phase-separated fine particulate including the non-polymerizable solvent in its inside.

The average particle size calculated from the optical micrograph was 13 μm.

The degree of polymerization was 73.3%.

The porosity M was 50% by volume.

### Example 11

The phase-separated fine particulate obtained in Example 10 was subjected to isolation and drying at 80° C. for 24 hours and then observed by SEM. FIG. 5B shows the result. Some particles of the hollow fine particulate had a hollow structure with a cave-in.

A particle with a large cave-in was observed, and the surface of the particle had a porous surface. Since no distinct shell was observed in the optical micrograph, the porous surface was presumably formed by exposure of a porous portion.

### Example 12

Suspended particles dispersed in water were produced as in Example 8, except that the amount of the initiator was changed. Table 5 shows the composition.

TABLE 5

| | | Amount (g) |
|---|---|---|
| Fluorinated monomer | Monomer a7 | 0.24 |
| Crosslinkable monomer | PFDVE | 0.36 |
| Non-polymerizable solvent | HFCP | 0.6 |
| Particulate dispersion stabilizer | PVA | 0.02 |
| Polymerization initiator | BPO | 0.06 |
| Dispersion medium | Water | 5 |

FIG. 6 shows an optical micrograph of suspended particles dispersed in water after polymerization. The optical micrograph after polymerization indicates that particles with a hollow structure (pores) were obtained.

The obtained suspended particles dispersed in water were a phase-separated fine particulate including the non-polymerizable solvent in its inside.

The average particle size calculated from the optical micrograph was 13 μm.

The porosity M was 50% by volume.

### Example 13

The phase-separated fine particulate obtained in Example 12 was subjected to isolation and drying at 70° C. for 24 hours, thereby obtaining a hollow fine particulate with a spherical structure. A surface with a partially exposed hollow structure was observed by SEM.

### Example 14

Suspended particles dispersed in water were produced as in Example 1, except that the composition was changed to the one shown in Table 6, the polymerization temperature was changed to 80° C., and the polymerization time was changed to nine hours.

TABLE 6

| | | Amount (g) |
|---|---|---|
| Fluorinated monomer | Monomer a7 | 1.2 |
| Non-polymerizable solvent | HFCP | 1.2 |
| Particulate dispersion stabilizer | PVA | 0.2 |
| Polymerization initiator | BPO | 0.024 |
| Dispersion medium | Water | 10 |

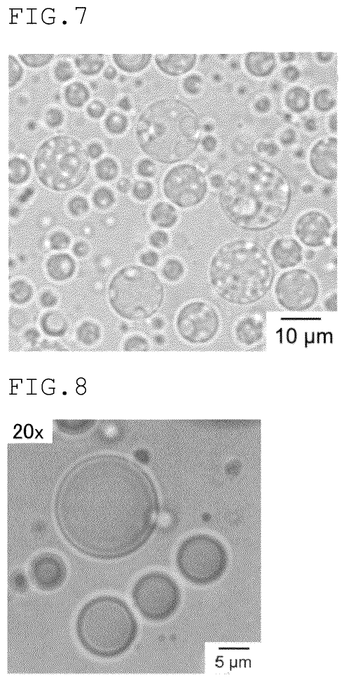

FIG. 7 shows an optical micrograph of suspended particles dispersed in water after polymerization. The optical micrograph after polymerization indicates that particles with a hollow structure (relatively large pores) were obtained.

The obtained suspended particles dispersed in water were a phase-separated fine particulate including the non-polymerizable solvent in its inside.

The average particle size calculated from the optical micrograph was 7.2 μm.

### Example 15

The phase-separated fine particulate obtained in Example 14 was subjected to isolation and drying at 80° C. for nine hours, thereby obtaining a hollow fine particulate with a spherical structure.

Exposure of a porous structure on the surface was not observed by SEM presumably due to the relatively large porous structure.

The glass transition temperature of the fluorine-containing resin in the hollow fine particulate obtained in Example 15 was measured and found to be 129° C.

### Example 16

Suspended particles dispersed in water were produced as in Example 1, except that the composition was changed to the one shown in Table 7, and the polymerization temperature was changed to 70° C.

TABLE 7

| | | Amount (g) |
|---|---|---|
| Fluorinated monomer | Monomer a7 | 0.31 |
| Crosslinkable monomer | PFDVE | 0.29 |
| Non-polymerizable solvent | HFCP | 0.6 |
| Particulate dispersion stabilizer | PVA | 0.2 |
| Polymerization initiator | BPO | 0.012 |
| Dispersion medium | Water | 10 |

FIG. 8 shows an optical micrograph of suspended particles dispersed in water after polymerization. The optical micrograph after polymerization indicates that particles with a hollow structure (single pore) were obtained.

The obtained suspended particles dispersed in water were a phase-separated fine particulate including the non-polymerizable solvent in its inside.

The average particle size calculated from the optical micrograph was 11 μm.

The phase-separated fine particulate had a porosity M of 50% by volume.

### Examples 17 to 22

Table 8 shows the compositions, polymerization conditions, and polymerization results. The CF₂═CF—OC₃F₇, CH₂═CH—C₆F₁₃, and CH₂═CF(CF₂OCFCF₃)₂CH₂OH, which are fluorinated monomers, had fluorine conversion FC of 100%, 81%, and 76%, respectively.

TABLE 8

| | | | Exam- | Exam- | Exam- | Exam- | Exam- | Exam- |
|---|---|---|---|---|---|---|---|---|
| | | | ple 17 | ple 18 | ple 19 | ple 20 | ple 21 | ple 22 |
| Composition | Fluorinated monomer | Monomer a7 | 0.36 | 0.31 | 0.31 | 0.84 | 0.84 | — |
| | | CF₂═CF—OC₃F₇ | — | — | — | 0.36 | — | — |
| | | CH₂═CH—C₆F₁₃ | — | — | — | — | 0.36 | — |
| | | CH₂═CF(CF₂OCFCF₃)₂CH₂OH | — | — | — | — | — | 0.6 |
| | Crosslinkable monomer | PFDVE | 0.24 | 0.29 | 0.29 | — | — | 0.6 |
| | Non-polymerizable solvent | HFCP | 0.9 | 0.6 | 0.6 | 1.2 | 1.2 | 1.2 |
| | Particulate dispersion | PVA | 0.02 | 0.02 | 0.02 | — | — | — |
| | stabilizer | Fluorine-containing Particulate | — | — | — | 0.1 | 0.1 | 0.1 |
| | | dispersion stabilize | | | | | | |
| | Polymerization initiator | BPO | — | 0.012 | 0.06 | — | — | — |
| | | Lauroyl peroxide | 0.012 | — | — | — | — | — |
| | | 40% Methanol solution of | — | — | — | 0.05 | 0.05 | 0.05 |
| | | di-n-propyl peroxydicarbonate | | | | | | |
| | pH adjuster | NH3 | — | — | — | 0.025 | 0.025 | 0.025 |
| | Dispersion medium | Water | 5 | 5 | 5 | 10 | 10 | 10 |
| Polymerization | Temperature | ° C. | 60 | 80 | 70 | 40 | 40 | 40 |
| conditions | Time | h | 24 | 24 | 24 | 20 | 20 | 20 |
| | Stirring conditions | rpm | 180 | 350 | 350 | 350 | 350 | 350 |
| Polymerization | Average particle size | μm | 13.3 | 13.8 | 11.6 | 9.5 | 10.5 | 7.5 |
| result | Hollow shape | Optical microscopic observation | Porous | Porous | Porous | Porous | Porous | Porous |
| | Porosity | % | 60 | 50 | 50 | 50 | 50 | 50 |
| | Degree of polymerization | % | — | 73.3 | 55 | — | — | — |

The fluorine-containing particulate dispersion stabilizer used was a homopolymer of CH₂═CFCF₂OCF(CF₃)COOH having a Mw of 430,000.

The values in the composition section are the amounts (g).

The same applies to the following tables 9 and 10.

### Comparative Examples 1 and 2

Table 9 shows the compositions, polymerization conditions, and polymerization results.

TABLE 9

| | | | Comparative | Comparative |
|---|---|---|---|---|
| | | | Example 1 | Example 2 |
| Composition | Fluorinated monomer | Monomer a7 | 0.36 | 0.6 |
| | Crosslinkable monomer | PFDVE | 0.24 | — |
| | Non-polymerizable solvent | HFCP | — | — |
| | Particulate dispersion stabilizer | PVA | 0.02 | 0.02 |
| | Polymerization initiator | BPO | — | — |
| | | Lauroyl peroxide | 0.012 | 0.012 |
| | Dispersion medium | Water | 5 | 5 |
| Polymerization | Temperature | ° C. | 60 | 60 |
| conditions | Time | h | 24 | 24 |
| | Stirring conditions | rpm | 180 | 200 |
| Polymerization | Average particle size | μm | 25 | 20 |
| result | Hollow shape | Optical microscopic | None | None |
| | | observation | | |
| | Porosity | % | — | — |
| | Degree of polymerization | % | — | — |

No hollow structure was obtained in the comparative examples.

### Examples 23 to 25

Table 10 shows the compositions, polymerization conditions, and polymerization results.

TABLE 10

| | | | Example 23 | Example 24 | Example 25 |
|---|---|---|---|---|---|
| Composition | Fluorinated monomer | Monomer a7 | 0.3 | 0.42 | 0.18 |
| | Crosslinkable monomer | Ethylene glycol | 0.3 | 0.18 | 0.42 |
| | | di(meth)acrylate | | | |
| | Non-polymerizable solvent | HFCP | 0.6 | 0.6 | 0.6 |
| | Particulate dispersion stabilizer | PVA | 0.1 | 0.1 | 0.1 |
| | Polymerization initiator | BPO | 0.012 | 0.012 | 0.012 |
| | Dispersion medium | Water | 5 | 5 | 5 |
| Polymerization | Temperature | ° C. | 70 | 70 | 70 |
| conditions | Time | h | 5 | 24 | 24 |
| | Stirring conditions | rpm | 180 | 180 | 180 |
| Polymerization | Hollow shape | Optical microscopic | Porous | Porous | Porous |
| result | | observation | | | |
| | Porosity | % | 50 | 50 | 50 |
| | Degree of polymerization | % | 55 | 99> | 86 |

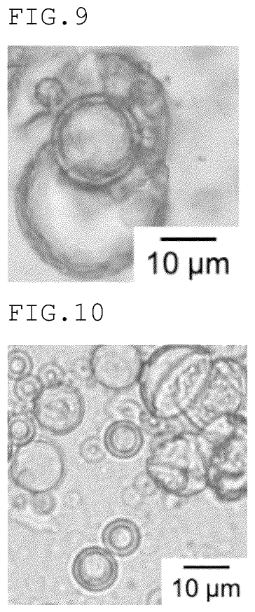

FIG. 9 shows an optical micrograph of suspended particles dispersed in water after polymerization obtained in Example 23. The optical micrograph after polymerization indicates that particles with a hollow structure (relatively large pores) were obtained.

The obtained suspended particles dispersed in water were a phase-separated fine particulate including the non-polymerizable solvent in its inside.

The average particle size calculated from the optical micrograph was 17 μm.

The phase-separated fine particulate had a porosity M of 50% by volume.

FIG. 10 shows an optical micrograph of suspended particles dispersed in water after polymerization obtained in Example 24. The optical micrograph after polymerization indicates that particles with a hollow structure (relatively small pores) were obtained.

The obtained suspended particles dispersed in water were a phase-separated fine particulate including the non-polymerizable solvent in its inside.

The average particle size calculated from the optical micrograph was 6 μm.

The phase-separated fine particulate had a porosity M of 50% by volume.

### Example 26

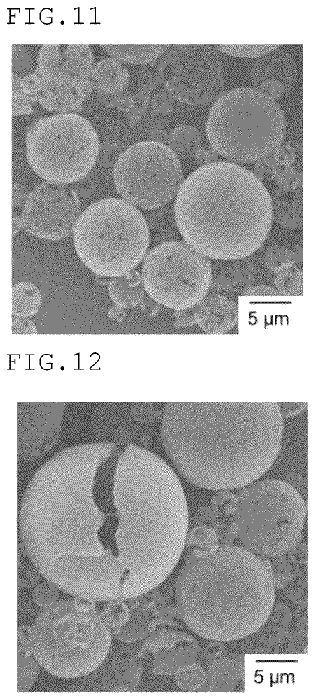

The phase-separated fine particulate obtained in Example 23 was subjected to isolation and drying at 80° C. for nine hours and then observed by SEM. FIG. 11 and FIG. 12 show the result. A hollow structure was confirmed in FIG. 12, demonstrating that a hollow fine particulate was obtained.

### Example 27

The phase-separated fine particulate obtained in Example 24 was subjected to isolation and drying at 80° C. for nine hours and then observed by SEM. FIG. 13 shows the result. The right side of FIG. 13 shows an enlarged view of the image in the frame. A hollow nesting structure was confirmed in FIG. 13, demonstrating that a hollow fine particulate was obtained.

### Examples 28 and 29

Table 11 shows the compositions, polymerization conditions, and polymerization results.

TABLE 11

| | | | Example 28 | Example 29 |
|---|---|---|---|---|
| Composition | Fluorinated monomer | Monomer a7 | 0.2 | 0.25 |
| | Crosslinkable monomer | PFDVE | — | — |
| | Non-polymerizable solvent | HFCP | 0.2 | 0.25 |
| | Particulate dispersion stabilizer | PVA | — | 0.0375 |
| | | CF₂═CFCF₂CF₂SO₃H | 0.017 | 0.0125 |
| | | homopolymer | | |
| | Polymerization initiator | BPO | 0.004 | 0.025 |
| | pH adjuster | NH₃ | 0.027 | 0.04 |
| | Dispersion medium | Water | 1.667 | 5 |
| Polymerization | Temperature | ° C. | 80 | 80 |
| conditions | Time | h | 24 | 24 |
| | Stirring conditions | rpm | 180 | 180 |
| Polymerization | Hollow shape | Optical microscopic | Porous | Porous |
| result | | observation | | |
| | Porosity | % | 50 | 50 |
| | Degree of polymerization | % | — | 47.8 |

In Examples 28 and 29, the particulate dispersion stabilizer used was a homopolymer of CF₂═CFCF₂CF₂SO₃H having a Mw of 10,000.

### Example 30

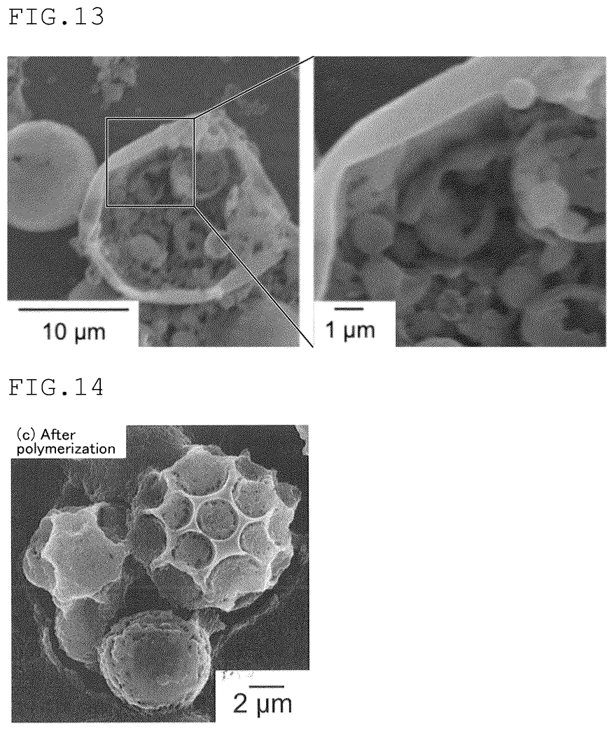

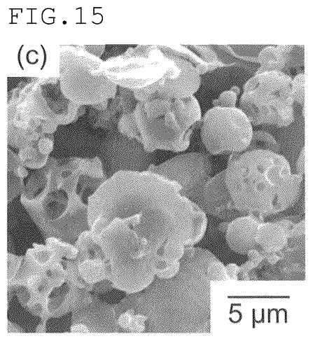

The phase-separated fine particulate obtained in Example 28 was subjected to isolation and drying at 80° C. for nine hours and then observed by SEM. FIG. 14 shows the result. Pores are observed in FIG. 14, demonstrating that a hollow fine particulate was obtained.

### Example 31

The phase-separated fine particulate obtained in Example 29 was subjected to isolation and drying at 80° C. for nine hours and then observed by SEM. FIG. 15 shows the result. Pores are observed in FIG. 15, demonstrating that a hollow fine particulate was obtained.

1. A method for producing a hollow fine particulate comprising:
a step A of dispersing a solution containing a fluorinated monomer and a non-polymerizable solvent into water to provide a dispersion;
a step B of polymerizing the fluorinated monomer to provide a phase-separated fine particulate containing a fluorine-containing resin, the phase-separated fine particulate including a monolayer structured shell and a core including the non-polymerizable solvent therein; and
a step C of removing the non-polymerizable solvent in the phase-separated fine particulate to provide a hollow fine particulate having an average particle size of 1.0 μm or greater.

2. The method for producing a hollow fine particulate according to claim 1,
wherein in the step A, the dispersion contains at least one particulate dispersion stabilizer selected from the group consisting of the following (A), (B) and (C);
(A)
at least one high molecular weight dispersion stabilizers selected from the group consisting of polyvinyl alcohol, methyl cellulose, ethyl cellulose, polyacrylic acid, polymethacrylic acid, polyacrylimide, polyethylene oxide, polyvinyl pyrrolidone, and a poly(hydroxystearic acid-g-methyl methacrylate-co-methacrylic acid) copolymer;
(B)
a fluoropolymer (α) of at least one monomer (α) selected from the formula (1a): CF₂═CF—O—Rf-A and the formula (2a): 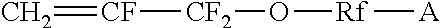
wherein Rf is a C1-C40 fluorine-containing alkylene group, a C2-C100 fluorine-containing alkylene group containing an ether bond, or a C2-C100 fluorine-containing alkylene group containing a keto group; A is —COOM, —SO₃M, —OSO₃M, or —C(CF₃)₂OM (wherein M is H, a metal atom, NR⁷₄, an optionally substituted imidazolium, an optionally substituted pyridinium, or an optionally substituted phosphonium; and R is H or an organic group;
(C)
an anionic fluorine-containing surfactant represented by the formula (1): 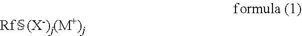
wherein Rf [symbol] is a C1-C30 (per)fluoroalkyl chain or a (per)fluoro(poly)oxyalkylene chain; X⁻ is —COO—, —PO₃—, or —SO₃—; M⁺ is selected from H⁺, NH₄⁺, and an alkali metal ion; and j may be 1 or 2.

3. The method for producing a hollow fine particulate according to claim 1,
wherein the fluorinated monomer is a high-fluorine-conversion monomer having a fluorine conversion FC of 70% or higher, the fluorine conversion FC being calculated by the following formula:
$$Fluorine conversion FC ( \% ) = ( the number of C - F bonds in a monomer molecule ) \text{} / \{ ( the number of C - F bonds in a monomer molecule ) + ( the number of C - H bonds in a monomer molecule ) \} \times 100.$$

4. The method for producing a hollow fine particulate according to claim 3,
wherein the high-fluorine-conversion monomer is a high-fluorine-conversion cyclic olefin or a monomer represented by the following formula (b), (d), or (e): 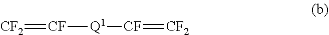
wherein Q¹ is a C1-C5 linear or optionally branched perfluoroalkylene group optionally containing an ether bond; 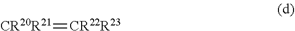
wherein R²⁰ to R²³ are each independently a fluorine atom, a C1-C5 perfluoroalkyl group, or a C1-C5 perfluoroalkoxy group; or 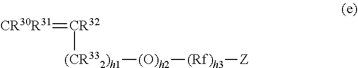
wherein R³⁰ and R³¹ are each independently H or F; R³² is H, F, or CF₃; R³³ is H, F, or CF₃; h1 to h3 are each independently 0 or 1; Z is H, F, Cl, —OH, CH₂OH, —COOH, —COF, a carboxylic acid derivative, —SO₃H, a sulfonic acid derivative, an epoxy group, or a cyano group; and Rf is a C1-C20 linear or branched fluorine-containing alkylene group or a C2-C100 linear or branched fluorine-containing alkylene group containing an ether bond.

5. The method for producing a hollow fine particulate according to claim 4,
wherein the high-fluorine-conversion cyclic olefin is a monomer represented by the following formula (a) or (c): 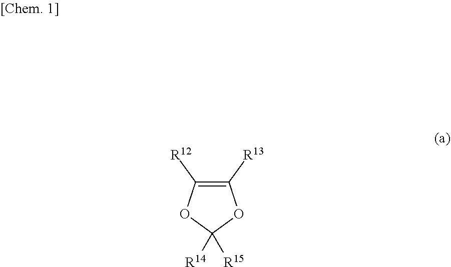
wherein R¹² to R¹⁵ are each independently a fluorine atom, a C1-C5 perfluoroalkyl group, or a C1-C5 perfluoroalkoxy group; or 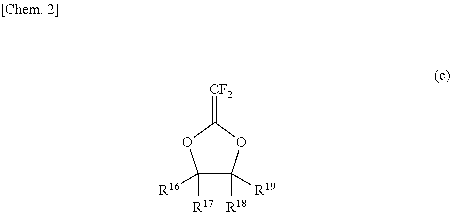
wherein R¹⁶ to R¹⁹ are each independently a fluorine atom, a C1-C5 perfluoroalkyl group, or a C1-C5 perfluoroalkoxy group.

6. The method for producing a hollow fine particulate according to claim 5,
wherein the high-fluorine-conversion olefin is a monomer represented by the formula (c).

7. The method for producing a hollow fine particulate according to claim 1,
wherein the solution further contains a crosslinkable monomer.

8. The method for producing a hollow fine particulate according to claim 7,
wherein the crosslinkable monomer is a multifunctional monomer containing two or more polymerizable reactive groups.

9. The method for producing a hollow fine particulate according to claim 8,
wherein the crosslinkable monomer is:
CF₂═CF—O—(CF₂)ₙ—O—CF═CF₂, wherein n=1 to 20;
CF₂═CF—(CF₂)ₙ—O—CF═CF₂, wherein n=1 to 20; or
CF₂═CF—(CF₂)ₘ—CF═CF₂, wherein m=1 to 20.

10. The method for producing a hollow fine particulate according to claim 1,
wherein the non-polymerizable solvent is a fluorine-containing non-polymerizable solvent.

11. The method for producing a hollow fine particulate according to claim 10,
wherein the fluorine-containing non-polymerizable solvent includes at least one selected from the group consisting of a perfluoro aromatic compound, a perfluorotrialkylamine, a perfluoroalkane, a hydrofluorocarbon, a perfluoro cyclic ether, a fluorine-containing alcohol, and a hydrofluoroether.

12. The method for producing a hollow fine particulate according to claim 1,
wherein the hollow fine particulate has a porosity of 30% by volume or higher.

13. A hollow fine particulate comprising:
a fluorine-containing resin containing a polymerized unit based on a fluorinated monomer,
the hollow fine particulate containing substantially no non-polymerizable solvent,
the hollow fine particulate having an average particle size of 1.0 μm or greater and having a porosity of 40% by volume or higher.

14. The hollow fine particulate according to claim 13,
wherein the fluorinated monomer is a high-fluorine-conversion monomer having a fluorine conversion FC of 70% or higher, the fluorine conversion FC being calculated by the following formula:
$$Fluorine conversion FC ( \% ) = ( the number of C - F bonds in a monomer molecule ) \text{} / \{ ( the number of C - F bonds in a monomer molecule ) + ( the number of C - H bonds in a monomer molecule ) \} \times 100.$$

15. The hollow fine particulate according to claim 14,
wherein the high-fluorine-conversion monomer is a high-fluorine-conversion cyclic olefin or a monomer represented by the following formula (b), (d), or (e): 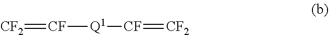
wherein Q¹ is a C1-C5 linear or optionally branched perfluoroalkylene group optionally containing an ether bond; 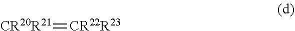
wherein R²⁰ to R²³ are each independently a fluorine atom, a C1-C5 perfluoroalkyl group, or a C1-C5 perfluoroalkoxy group; or 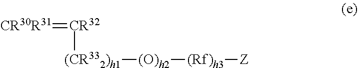
wherein R³⁰ and R³¹ are each independently H or F; R³² is H, F, or CF₃; R³³ is H, F, or CF₃; h1 to h3 are each independently 0 or 1; Z is H, F, Cl, —OH, CH₂OH, —COOH, —COF, a carboxylic acid derivative, —SO₃H, a sulfonic acid derivative, an epoxy group, or a cyano group; and Rf is a C1-C20 linear or branched fluorine-containing alkylene group or a C2-C100 linear or branched fluorine-containing alkylene group containing an ether bond.

16. The hollow fine particulate according to claim 15,
wherein the high-fluorine-conversion cyclic olefin is a monomer represented by the following formula (a) or (c): 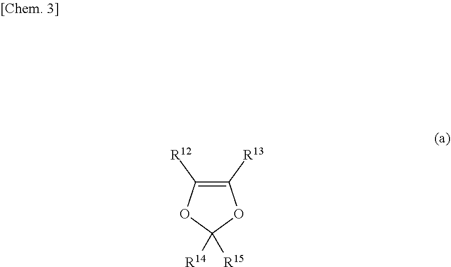
wherein R¹² to R¹⁵ are each independently a fluorine atom, a C1-C5 perfluoroalkyl group, or a C1-C5 perfluoroalkoxy group; or 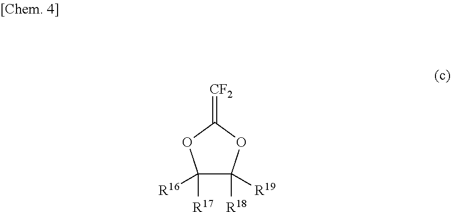
wherein R¹⁶ to R¹⁹ are each independently a fluorine atom, a C1-C5 perfluoroalkyl group, or a C1-C5 perfluoroalkoxy group.

17. The hollow fine particulate according to claim 16,
wherein the high-fluorine-conversion olefin is a monomer represented by the formula (c).

18. The hollow fine particulate according to claim 13,
wherein the fluorine-containing resin further contains a polymerized unit based on a crosslinkable monomer.

19. The hollow fine particulate according to claim 18,
wherein the crosslinkable monomer is a multifunctional monomer containing two or more polymerizable reactive groups.

20. The hollow fine particulate according to claim 19,
wherein the crosslinkable monomer is:
CF₂═CF—O—(CF₂)ₙ—O—CF═CF₂, wherein n=1 to 20;
CF₂═CF—(CF₂)ₙ—O—CF═CF₂, wherein n=1 to 20; or
CF₂═CF—(CF₂)ₘ—CF═CF₂, wherein m=1 to 20.

21. The hollow fine particulate according to claim 13,
wherein the fluorine-containing resin contains at least one particulate dispersion stabilizer selected from the group consisting of the following (A), (B) and (C);
(A)
at least one high molecular weight dispersion stabilizers selected from the group consisting of polyvinyl alcohol, methyl cellulose, ethyl cellulose, polyacrylic acid, polymethacrylic acid, polyacrylimide, polyethylene oxide, polyvinyl pyrrolidone, and a poly(hydroxystearic acid-g-methyl methacrylate-co-methacrylic acid) copolymer;
(B)
a fluoropolymer (α) of at least one monomer (α) selected from the formula (1a): CF₂═CF—O—Rf-A and the formula (2a): 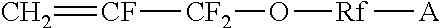
wherein Rf is a C1-C40 fluorine-containing alkylene group, a C2-C100 fluorine-containing alkylene group containing an ether bond, or a C2-C100 fluorine-containing alkylene group containing a keto group; A is —COOM, —SO₃M, —OSO₃M, or —C(CF₃)₂OM (wherein M is H, a metal atom, NR⁷₄, an optionally substituted imidazolium, an optionally substituted pyridinium, or an optionally substituted phosphonium; and R⁷ is H or an organic group;
(C)
an anionic fluorine-containing surfactant represented by the formula (1): 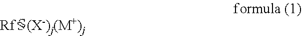
wherein Rf [symbol] is a C1-C30 (per)fluoroalkyl chain or a (per)fluoro(poly)oxyalkylene chain; X⁻ is —COO—, —PO₃—, or —SO₃—; M⁺ is selected from H⁺, NH₄⁺, and an alkali metal ion; and j may be 1 or 2.

22. The hollow fine particulate according to claim 13, which is used for an electronic material.

23. A composition comprising:
the hollow fine particulate according to claim 13; and
a fluorine-containing resin containing a polymerized unit based on a fluorinated monomer.
